(19) United States
(12) Patent Application Publication
(10) Pub. No.: US 2017/0168285 A1
(43) Pub. Date: Jun. 15, 2017

(54) SYSTEMS AND METHODS FOR IMAGE RECONSTRUCTION

(71) Applicant: THE REGENTS OF THE UNIVERSITY OF CALIFORNIA, Oakland, CA (US)

(72) Inventors: Aydogan Ozcan, Los Angeles, CA (US); Wei Luo, Los Angeles, CA (US)

(73) Assignee: THE REGENTS OF THE UNIVERSITY OF CALIFORNIA, Oakland, CA (US)

(21) Appl. No.: 15/379,143

(22) Filed: Dec. 14, 2016

Related U.S. Application Data
(60) Provisional application No. 62/267,186, filed on Dec. 14, 2015.

(51) Int. Cl. G02B 21/36; G03H 1/00; H04N 5/265; G02B 21/00; H04N 5/225; H04N 5/357

(52) U.S. Cl. CPC G02B 21/367; H04N 5/2256; H04N 5/357; H04N 5/265; G02B 21/0056; G03H 1/0005; G03H 2001/005; G03H 2226/02

(57) ABSTRACT

A method for obtaining a high resolution image of objects contained within a sample is disclosed that combines pixel super-resolution and phase retrieval techniques into a unified algorithmic framework that enables new holographic image reconstruction methods with significantly improved data efficiency, i.e., using much less number of raw measurements to obtain high-resolution and wide-field reconstructions of the sample. Using the unified algorithmic framework, twin image noise and spatial aliasing signals, along with other digital holographic artifacts, can be interpreted as noise terms modulated by digital phasors, which are all analytical functions of the imaging parameters including e.g., the lateral displacement between the hologram and the sensor array planes (x, y shifts), sample-to-image sensor distance (z), illumination wavelength (λ), and the angle of incidence (θ,φ).

### RELATED APPLICATION

This application claims priority to U.S. Provisional Patent Application No. 62/267,186 filed on Dec. 14, 2015, which is hereby incorporated by reference in its entirety. Priority is claimed pursuant to 35 U.S.C. §119 and any other applicable statute.

### TECHNICAL FIELD

The technical field generally relates methods and devices used for high-resolution imaging. More particularly, the method and device relates to digital holographic imaging techniques although the methods and concepts described herein may also be used in conjunction with lenses in some embodiments.

### BACKGROUND

High-resolution wide-field optical imaging is needed in various fields, especially in medical and engineering applications that demand large space-bandwidth-products. Originally invented for electron microscopy, holography has become an emerging solution for high-resolution and wide-field digital imaging. The concept of holography relies on reconstructing the image of a sample using interference patterns created by the diffracted object fields, which can be recorded and digitized even without the use of any lenses. Recent advances in digital holographic microscopy have largely benefited from the rapid evolution of e.g., the opto-electronic sensor technology and computing power, which have led to the development of various new imaging configurations and reconstruction techniques

To achieve high-resolution and wide field-of-view, digital holographic imaging techniques need to tackle two major challenges: phase recovery and spatial undersampling. Previously, these challenges were separately addressed using phase retrieval and pixel super-resolution algorithms, which utilize the diversity of different imaging parameters. For example, various super-resolution techniques have been implemented to mitigate resolution loss by utilizing sub-pixel displacements in the imaging system, achieved, for example, by shifting the light source, the sensor-array and/or the sample, followed by digital synthesis of a smaller effective pixel by merging these sub-pixel-shifted low-resolution images.

Conventional pixel-super resolution relies on digital synthesis of high spatial frequency content of the sample using multiple low-resolution measurements that are recorded at different sub-pixel displacements (e.g., lateral displacements in the x, y direction) between the image sensor and object planes. Using this mathematical framework, high-resolution (i.e., super-resolved) holograms can be obtained, and then used for digital phase retrieval. To retrieve the lost optical phase in an in-line imaging geometry, multiple super-resolved holograms can be utilized at e.g., different sample-to-image sensor distances, illumination angles. Each one of these holograms essentially serve as independent physical constraints on the amplitude of the optical field, which enables the use of an iterative algorithm to force the complex object field to be consistent with all these measurements. Although this sequential implementation of pixel super-resolution followed by phase retrieval has enabled digital holographic microscopy to deliver high-resolution and wide-field reconstructions with giga-pixel level throughput, they currently require large amounts of holographic data which can be a limit for high-speed or cost-effective imaging applications. For instance, in a multi-height configuration (i.e., using multiple sample-to-image sensor distances), if 4×4 pixel super-resolution (e.g., 4×4 lateral shifts in the x, y directions) is implemented at eight different heights, the total number of raw holograms to be captured becomes 128, which could be a limitation for high-speed imaging applications.

### SUMMARY

In one embodiment, a method for obtaining a high resolution image of objects contained within a sample is disclosed that combines pixel super-resolution and phase retrieval techniques into a unified algorithmic framework that enables new holographic image reconstruction methods with significantly improved data efficiency, i.e., using much less number of raw measurements to obtain high-resolution and wide-field reconstructions of the sample. Using the unified algorithmic framework, the twin image noise and spatial aliasing signals, along with other digital holographic artifacts, can be interpreted as noise terms modulated by digital phasors, which are all analytical functions of the imaging parameters including e.g., the lateral displacement between the hologram and the sensor array planes (e.g., x, y shifts), sample-to-image sensor distance (z), illumination wavelength (λ), and the angle of incidence (θ,φ). Based on this new propagation phasor approach, a two-stage holographic image reconstruction algorithm was developed that merges phase retrieval and pixel super-resolution into the same unified framework. Compared to previous holographic reconstruction algorithms, this new computational method reduces the number of raw measurements by five to seven-fold, while at the same time achieving a competitive spatial resolution across a large field-of-view.

In one aspect of the invention, the computational framework that employs the propagation phasor-based approach acquires a plurality of raw measurements or holograms of a sample. These holograms are used to generate a high-resolution initial guess of the sample in a first stage (Stage I) of the process. This initial guess is made by first upsampling each raw measurement using an upsampling factor. The upsampled raw measurements are then offset with lateral displacements (x_{shift, k}, and y_{shift, k}) and subject to back-propagation. The upsampled and back-propagated holograms are subject to a summation process to generate the initial guess. The initial guess that is generated as a result of the first stage is then used as the input to an iterative algorithm to reconstruct and refine the image of the sample. This iterative process is used to eliminate the remaining twin image noise, aliasing signal, and upsampling artifacts. This second stage (Stage II) involves four different operations. First, phase modulation is applied to the initial guess and the field is propagated from the object plane to the image sensor plane (i.e., forward-propagation). At the image sensor plane, the low-resolution, undersampled holograms are used to update the amplitude of the high-resolution, forward-propagated field. The amplitude-updated, high-resolution field is then back-propagated to the object plane and phase modulation is removed that is caused by the illumination angle. The back-propagated field is then used to update the transmitted field on the object plane in the spatial frequency domain. After this update, the phase of the field is converted into an optical path length map of the sample, and the amplitude of the field is the reconstructed, final transmission image. The operations of Stage II are performed for every image configuration and iteratively are performed until convergence is reached.

In one aspect of the invention, the computational framework that employs the propagation phasor-based approach is executed on a computing device having one or more processors. The propagation phasor-based holographic reconstruction algorithm may be executed using, for example, MATLAB® or other software or imaging program (e.g., the software may be written in C or similar programming language). Because the bulk of computation time is spent on wave propagation between the sample plane and the image sensor plane, which relies on Fast Fourier Transforms (FFTs), the use of one or more graphic processing units (GPUs) or other parallel computing architecture may reduce the total computation time and accelerate the image reconstruction process.

In one embodiment of the invention, the propagation phasor-based holographic reconstruction algorithm is used to reconstruct pixel super-resolution images using diversity of sample-to-image sensor distance (i.e., z). In another embodiment of the invention, the propagation phasor-based holographic reconstruction algorithm is used to reconstruct pixel super-resolution images using diversity of angle (i.e., (θ,φ). In another embodiment of the invention, the propagation phasor-based holographic reconstruction algorithm is used to reconstruct pixel super-resolution images using diversity of wavelength (λ). In another embodiment, the propagation phasor-based holographic reconstruction algorithm is used to reconstruct pixel super-resolution images based on diversity of sample-to-image sensor distance as well as sub-pixel lateral shifts performed at one sample-to-image sensor distance. In another embodiment, the propagation phasor-based holographic reconstruction algorithm is used to reconstruct pixel super-resolution images based on diversity of angle as well as sub-pixel lateral shifts performed at one angle. In another embodiment, the propagation phasor-based holographic reconstruction algorithm is used to reconstruct pixel super-resolution images based on diversity of wavelength as well as diversity of sample-to-image sensor distance. In another embodiment, the propagation phasor-based holographic reconstruction algorithm is used to reconstruct pixel super-resolution images based on diversity of wavelength as well as diversity of angle.

In one embodiment, wavelength-scanning is used for pixel super-resolution imaging that generates high-resolution reconstructions form undersampled raw measurements captured at multiple wavelengths within a relatively narrow spectral range (e.g., 10-30 nm). Compared with lateral (x, y) shift-based super-resolution, the wavelength-scanning method avoids the need for shifting mechanical components and, more importantly, provides uniform resolution improvement along all the directions across the image sensor or sample plane. This framework enables one to improve the resolution and effective NA of a wide-field lens-free microscope by a factor of approximately four, achieving a half-pitch resolution of 250 nm with an NA of approximately 1.0 using significantly fewer measurements compared with those required by lateral shift-based super-resolution methods. Because the wavelength-scanning super-resolution technique utilizes a narrow spectral range, it allows for super-resolved imaging of both colorless (e.g., unstained) and stained/dyed biological samples. Reconstructions at multiple wavelengths also enable robust phase unwrapping to reveal the optical path length differences between the sample and surrounding media. This new wavelength-scanning super-resolution approach would broadly benefit various lens-free as well as lens-based wide-field and high-throughput microscopy applications that require large space-bandwidth products.

In one embodiment, a method for obtaining a high resolution image of one or more objects contained within a sample includes illuminating the sample with a light source emitting partially coherent light or coherent light, wherein the sample is interposed between the light source and an image sensor with a sample-to-image sensor distance zₖ. A plurality of lower resolution hologram image frames of the objects are obtained with the image sensor, wherein the plurality of lower resolution hologram image frames are obtained at different (1) sample-to-image sensor distances zₖ or (2) different illumination angles θₖ,φₖ. A high-resolution initial guess of the objects is generated from the plurality of lower resolution hologram image frames based on a summation of upsampled holograms in the lower resolution image frames. Twin image noise, aliasing signal, and artifacts are iteratively eliminated and phase information is retrieved from the high-resolution initial guess. The iterative process involves: forward-propagating the high-resolution initial guess from an object plane to an image sensor plane to generate a high-resolution forward-propagated field; updating an amplitude of the high-resolution forward-propagated field using holograms in the lower resolution hologram image frames; back-propagating the updated high-resolution forward-propagated field to the object plane; updating a transmitted field of the object at the object plane in the spatial frequency domain; and outputting a phase retrieved high resolution image of the one or more objects contained within the sample based on the updated transmitted fields of the one or more object.

In another embodiment, a method for obtaining a high resolution image of one or more objects contained within a sample includes sequentially illuminating the sample at a plurality of different wavelengths with a light source emitting partially coherent light or coherent light, wherein the sample is interposed between the light source and an image sensor with a sample-to-image sensor distance zₖ. The light source may be a wavelength-tunable light source or multiple different light sources emitting light at different wavelengths. A plurality of lower resolution hologram image frames of the objects are obtained with the image sensor at the plurality of different wavelengths, wherein the plurality of lower resolution hologram image frames are also obtained at different (1) sample-to-image sensor distances zₖ or (2) different illumination angles θₖ,φₖ. A high-resolution initial guess of the objects is generated from the plurality of lower resolution hologram image frames based on a summation of upsampled holograms in the lower resolution image frames. The twin image noise, aliasing signal, and artifacts are iteratively eliminated and phase information is retrieved from the high-resolution initial guess. The iterative process includes forward-propagating the high-resolution initial guess from an object plane to an image sensor plane to generate a high-resolution forward-propagated field; updating an amplitude of the high-resolution forward-propagated field using holograms in the lower resolution hologram image frames; back-propagating the updated high-resolution forward-propagated field to the object plane; updating a transmitted field of the object at the object plane in the spatial frequency domain; and outputting a phase retrieved high resolution image of the one or more objects contained within the sample based on the updated transmitted field of the one or more objects.

In another embodiment, a wavelength scanning pixel super-resolution microscope device for imaging a sample includes a sample holder configured to hold the sample. The device includes a wavelength-tunable light source (or multiple different light sources) configured to illuminate the sample at a plurality of different wavelengths λₖ along an optical path. A lens or set of lenses are disposed along the optical path. The device includes an image sensor configured to receive illumination passing through the sample and lens or lens set along the optical path, wherein the at least one of the sample holder, lens/lens set, or image sensor are moveable along the optical path to introduce incremental defocusing conditions to the microscope device, wherein the image sensor obtains a plurality of images of the sample at the different wavelengths under the incremental defocusing conditions. The device includes at least one processor configured to (1) generate a high-resolution initial guess of the sample image based on the plurality of images of the sample at the different wavelengths under the incremental defocusing conditions, (2) iteratively eliminate artifacts and retrieving phase information from the high-resolution initial guess of the sample image, and (3) output a high resolution, phase retrieved high resolution image of the sample.

### BRIEF DESCRIPTION OF THE DRAWINGS

FIG. 1A schematically illustrates the configuration of an in-line holographic imaging system. Some of the controllable parameters of the imaging system are illustrated including the illumination angle (θₖ and φₖ), wavelength λₖ, sample-to-image sensor distance zₖ, and the lateral displacements between the hologram and the image sensor planes (x_{shift, k} and y_{shift, k}).

FIG. 1B schematically illustrates an optical setup of a lens-free holographic microscope according to one embodiment.

FIG. 1C schematically illustrates a system that incorporates a lens-free holographic microscope.

FIG. 2A illustrates the Stage I process of the propagation phasor-based holographic reconstruction method.

FIG. 2B illustrates the Stage II process of the propagation phasor-based holographic reconstruction method.

FIG. 2C illustrates the high-resolution, phase retrieved reconstruction of an object.

FIG. 3A illustrates the frequency spectrum of an upsampled and back-propagated hologram.

FIG. 3B illustrates the twin image phasor at (fₓ=0.1 μm⁻¹, f_{y}=0 μm⁻¹) as a function of lateral shifts between the hologram and the image sensor array, x_{shift, k} and y_{shift k}.

FIG. 3C illustrates twin image phasor at (fₓ=0.1 μm⁻¹, f_{y}=0 μm⁻¹) as a function of the sample to sensor-distance, zₖ.

FIG. 3D illustrates twin image phasor at (fₓ=0.1 μm⁻¹, f_{y}=0 μm⁻¹) as a function of the illumination wavelength, λₖ.

FIG. 3E illustrates twin image phasor at (fₓ=0.1 μm⁻¹, f_{y}=0 μm⁻¹) as a function of the illumination angle θₖ.

FIG. 3F illustrates the spatial aliasing phasor at (fₓ=0.8 μm⁻¹, f_{y}=−0.8 μm⁻¹) as a function of lateral shifts between the hologram and the image sensor array, x_{shift, k} and y_{shift k}.

FIG. 3G illustrates the spatial aliasing phasor at (fₓ=0.8 μm⁻¹, f_{y}=−0.8 μm⁻¹) as a function of the sample to sensor-distance, zₖ.

FIG. 3H illustrates the spatial aliasing phasor at (fₓ=0.8 μm⁻¹, f_{y}=−0.8 μm⁻¹) as a function of the illumination wavelength, λₖ.

FIG. 3I illustrates the spatial aliasing phasor at (fₓ=0.8 μm⁻¹, f_{y}=−0.8 μm⁻¹) as a function of the illumination angle θₖ.

FIG. 4A illustrates the partial derivatives of the twin image phasor's angle (Φ_{twin}) with respect to the lateral shifts x_{shift, k} and y_{shift, k}.

FIG. 4B illustrates the partial derivatives of the twin image phasor's angle (Φ_{twin}) with respect to the sample-to-image sensor distance zₖ.

FIG. 4C illustrates the partial derivatives of the twin image phasor's angle (Φ_{twin}) with respect to the illumination wavelength λₖ.

FIG. 4D illustrates the partial derivatives of the twin image phasor's angle (Φ_{twin}) with respect to the illumination angle θₖ.

FIG. 4E illustrates the partial derivatives to the spatial aliasing phasor angle (Φₐₗᵢₐₛ) with respect to the lateral shifts x_{shift, k} and y_{shift, k}.

FIG. 4F illustrates the partial derivatives to the spatial aliasing phasor angle (Φₐₗᵢₐₛ) with respect to the sample-to-image sensor distance zₖ.

FIG. 4G illustrates the partial derivatives to the spatial aliasing phasor angle (Φₐₗᵢₐₛ) with respect to the to the illumination wavelength λₖ.

FIG. 4H illustrates the partial derivatives to the spatial aliasing phasor angle (Φₐₗᵢₐₛ) with respect to the to the illumination angle θₖ.

FIG. 5A illustrates an image of a test target obtained using conventional multi-height based image reconstruction. At each of the 8 heights (i.e., sample-to-image sensor distances, 200 μm: 15 μm: 305 μm), only one raw hologram is used.

FIG. 5B illustrates an image of the test target using the propagation phasor approach-based reconstruction with improved resolution using the same data set used in FIG. 5A.

FIG. 5C illustrates an image of a test target obtained using conventional multi-angle based image reconstruction. At each of the nine illumination angles (−30°:15°:30°, two axes), only one raw hologram is used.

FIG. 5D illustrates an image of the test target using the propagation phasor approach-based reconstruction with improved resolution using the same data set used in FIG. 5C.

FIG. 6A illustrates an image of a test target obtained using conventional multi-height based image reconstruction. At each of the 8 heights (200 μm:15 μm:305 μm), 16 raw holograms (4×4) are acquired to generate pixel super-resolved holograms, which results in a total of 128 raw measurements.

FIG. 6B illustrates an image of the same test target of FIG. 6A using the propagation phasor approach-based reconstruction, using only 23 raw measurements. At only one of the heights (200 μm), 16 raw measurements are used for pixel super-resolution, while at each of the other heights, only one raw measurement is used.

FIG. 6C illustrates an image of a test target obtained using conventional angle change (i.e., synthetic aperture) approach. At each one of the 9 angles (−30°:15°:30°, two axes), 36 raw holograms are acquired to generate pixel super-resolved holograms, which results in a total of 324 raw measurements.

FIG. 6D illustrates an image of the same test target of FIG. 6C using the propagation phasor approach-based reconstruction, using only 44 raw measurements. At the normal illumination, 36 raw measurements are used for pixel super-resolution, while at each one of the other angles, only one raw measurement is used.

FIG. 7A illustrates an image of an unstained Pap smear obtained using conventional multi-height based image reconstruction.

FIG. 7B illustrates an image of an unstained Pap smear obtained using the propagation phasor approach-based reconstruction with the same data set used in FIG. 7A.

FIG. 7C illustrates an image of an unstained Pap smear obtained using the propagation phasor approach-based reconstruction, where at one of the heights (150 μm), 9 (3×3) raw measurements are used for pixel super-resolution, while at each of the other heights, only one raw measurement is used. Noticeable improvement in resolution is seen.

FIG. 7D illustrates an image of the unstained Pap smear obtained with a conventional phase contrast microscope image of the same sample using a 40× objective lens (NA=0.6).

FIG. 7E illustrates an image of an unstained Pap smear obtained using conventional synthetic aperture (i.e., multi-angle) based reconstruction. At each of the 13 illumination angles (−30°:10°:30°, two axes), only one raw measurement is used.

FIG. 7F illustrates an image of an unstained Pap smear obtained using the propagation phasor approach-based reconstruction with the same data set used in FIG. 7E.

FIG. 7G illustrates an image of an unstained Pap smear obtained using the propagation phasor approach-based reconstruction, where at the normal illumination, 9 (3×3) raw measurements are used for pixel super-resolution, while at each one of the other angles, only one raw measurement is used.

FIG. 7H illustrates an image of an unstained Pap smear obtained using a conventional bright-field microscope image of the same blood smear using a 20× objective lens (NA=0.45).

FIG. 8A illustrates an image of a test target obtained using propagation phasor approach-based reconstruction from a single raw measurement (510 nm and z=320 μm) captured by an image sensor chip with a pixel pitch of 1.12 μm.

FIG. 8B illustrates an image of the test target obtained using lens-free reconstructions using conventional lateral shift-based pixel super-resolution. The image of FIG. 8B is reconstructed using super-resolved holograms synthesized from five sub-pixel shifted raw measurements. The corresponding sub-pixel shifts of the raw measurements are marked within the hologram shift tables.

FIG. 8C illustrates an image of the test target obtained using lens-free reconstructions using conventional lateral shift-based pixel super-resolution. The image of FIG. 8C is reconstructed using super-resolved holograms synthesized from nine sub-pixel shifted raw measurements. The corresponding sub-pixel shifts of the raw measurements are marked within the hologram shift tables.

FIG. 8D illustrates an image of the test target obtained using wavelength-scanning pixel super-resolution, with five wavelengths used within a scanning range of 498-510 nm and a scan step size of 3 nm.

FIG. 9A illustrates an image of a test target obtained using lateral shift-based pixel super-resolution and multi-height phase retrieval (five sub-pixel shifted images at each height).

FIG. 9B illustrates an image of a test target obtained using lateral shift-based pixel super-resolution and multi-height phase retrieval (nine sub-pixel shifted images at each height).

FIG. 9C illustrates an image of a test target obtained using lens-free reconstruction using wavelength-scanning pixel super-resolution and multi-height phase retrieval. Here, five wavelengths are used with a scanning range of 498-510 nm and a scan step size of 3 nm at each height (five heights).

FIG. 10A illustrates an image of an object obtained using lens-free imaging using synthetic aperture (multi-angle) and lateral shift-based pixel super-resolution. At each illumination angle, 6×6=36 sub-pixel lateral shifts, which are spread evenly over the pixel area, are used for super-resolution.

FIG. 10B illustrates an image of the same object obtained using lens-free imaging using synthetic aperture and wavelength-scanning pixel super-resolution. Twelve wavelengths are used within a scanning range of 480-513 nm and a scan step of 3 nm. The illumination angle scanning directions, ranges and scanning steps are the same in both FIG. 10A and FIG. 10B.

FIG. 10C illustrates an image of the object obtained using a conventional lens-based microscope with a 60× water-immersion objective lens (NA=1.0).

FIG. 11A illustrates a lens-free image obtained of a Pap smear using wavelength-scanning pixel-super resolution and multi-height phase retrieval. Wavelength scanning range: 510-531 nm, scanning step: 3 nm.

FIG. 11B illustrates region of interest ROI 1 from FIG. 11A (lens-free reconstruction-phase).

FIG. 11C illustrates region of interest ROI 1 from FIG. 11A (lens-free reconstruction-digital phase contrast).

FIG. 11D illustrates region of interest ROI 1 from FIG. 11A obtained using a conventional phase contrast microscope (40× objective, NA=0.6).

FIG. 11E illustrates region of interest ROI 2 from FIG. 11A (lens-free reconstruction-phase).

FIG. 11F illustrates region of interest ROI 2 from FIG. 11A (lens-free reconstruction-digital phase contrast).

FIG. 11G illustrates region of interest ROI 2 from FIG. 11A obtained using a conventional phase contrast microscope (40× objective, NA=0.6).

FIG. 12A illustrates a lens-free image of a blood smear using wavelength-scanning pixel super-resolution and synthetic aperture phase retrieval. Wavelength scanning range: 520-541 nm, scanning step: 3 nm. Angle scanning (two axes) range: −35° to 35° with 5° steps. Lens-free raw hologram was captured using a CMOS image sensor with a pixel size of 1.12 μm and a FOV of approximately 20.5 mm².

FIG. 12B illustrates lens-free reconstruction of a sub-region, marked with a square within the full FOV.

FIG. 12C illustrates an image of the same area obtained with a conventional lens-based microscope image using a 20× objective lens (NA=0.45).

FIG. 13A illustrates a lens-free phase image obtained using a single wavelength; phase map is wrapped. The sample consists of four grating lines carved into a glass substrate using focused ion beam milling.

FIG. 13B illustrates an unwrapped lens-free phase image of the sample obtained from a single wavelength reconstruction using a 2D phase unwrapping technique based on minimum network flow.

FIG. 13C illustrates an unwrapped lens-free phase image obtained using reconstructions from multiple wavelengths. Eleven wavelengths are used within a scanning range of 501-531 nm and a scan step size of 3 nm.

FIG. 13D illustrates the depth profile of the image of FIG. 13A.

FIG. 13E illustrates the depth profile of the image of FIG. 13B.

FIG. 13F illustrates the depth profile of the image of FIG. 13C. The dashed line is the depth profile of the sample gratings measured using an atomic force microscope (AFM).

FIG. 14A schematically illustrates a wavelength scanning pixel super-resolution microscope device for imaging a sample. A 10× objective lens (NA=0.3) was used. The sample plane is scanned from 160 μm to 300 μm, defocused from the focal plane of the objective lens in 20 μm increments. The illumination wavelength is tuned between 500 nm and 521 nm with a step size of 3 nm.

FIG. 14B illustrates a full FOV image of a CMOS image sensor (pixel size: 3.75 μm) using the 10× objective lens with a 0.38× camera adaptor.

FIG. 14C illustrates a lens-based image of a resolution test chart without wavelength-scanning pixel super-resolution. The half-pitch of the smallest resolved feature is 1.95 μm.

FIG. 14D illustrates a lens-based image of the same resolution test chart with wavelength-scanning pixel super-resolution. The half-pitch of the smallest resolved feature is 0.78 μm.

### DETAILED DESCRIPTION OF THE ILLUSTRATED EMBODIMENTS

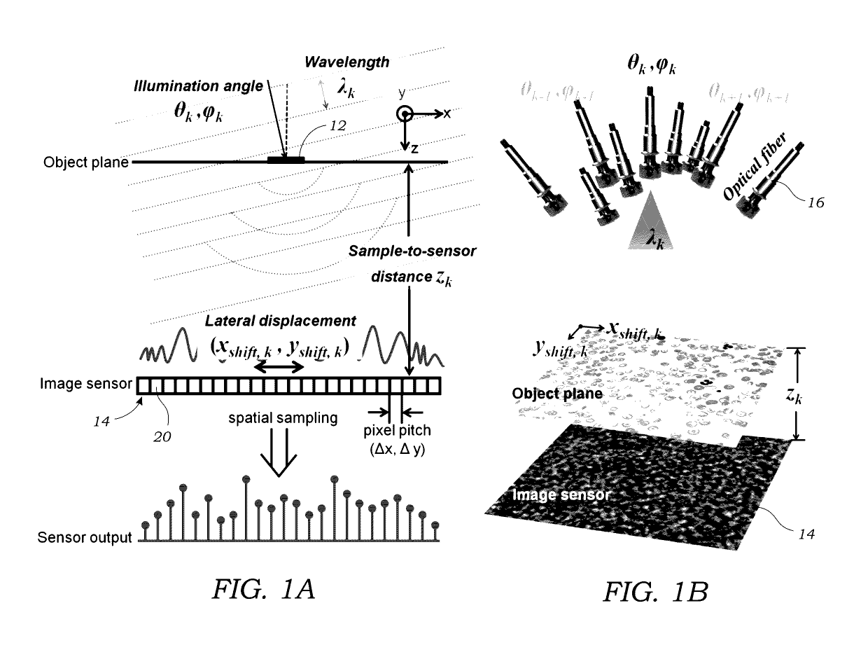

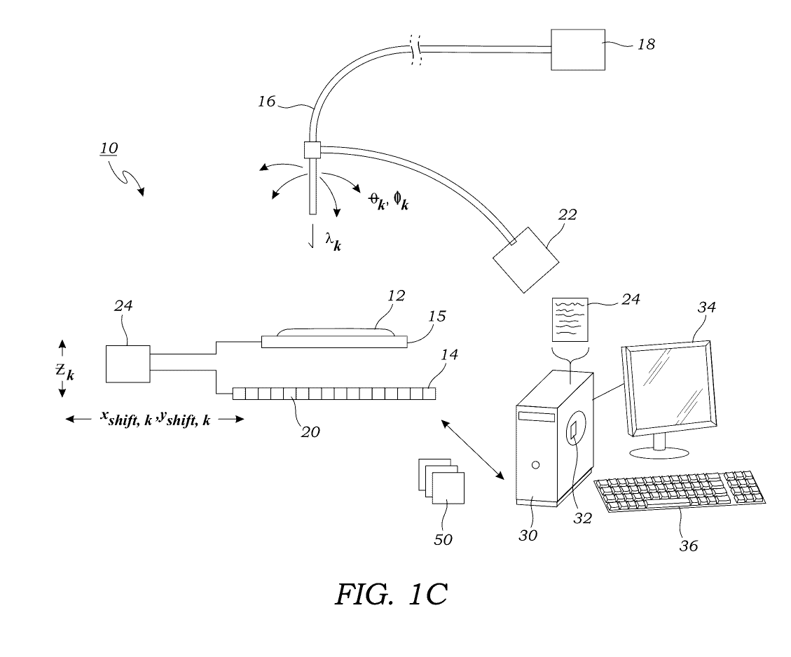

The configuration of an in-line holographic imaging system 10 according to one embodiment of the invention is seen with reference to FIGS. 1A-1C. In this embodiment, an object or sample 12 that is to be imaged is located at an object plane (object plane illustrated in FIG. 1A). An image sensor 14 is located on one side of the object or sample 12 at distance zₖ (seen in FIG. 1A) that represents the distance between the sample or object 12 and the active surface of the image sensor 14. The sample 12 may be located on a sample holder 15 as illustrated in FIG. 1C. Objects contained in the sample 12 are imaged with the in-line holographic imaging system 10. These may include individual cells, groupings of cells, organelles, cellular features, histological landmarks or features in the case of a biological-based sample. The sample holder 15 is typically made from an optically transparent material such as glass or a polymer-based material. The image sensor 14 may include a CCD or CMOS type image sensor 14. Partially coherent light or coherent light is illuminated on the object or sample 12 after passing through an optical fiber, optical cable, or other waveguide 16. The optical fiber, optical cable, or other waveguide 16 is coupled to a light source 18 as seen in FIG. 1C. The light source 18 may include a wavelength-tunable light source. The light has a wavelength λₖ and in some embodiments may be changed or incremented to provide for wavelength scanning as described herein. The light may be oriented with respect to the sample or object 12 at one or more illumination angles θₖ, and φₖ (in spherical coordinates). As an alternative to a wavelength-tunable light source 18, multiple different light sources 18; each emitting light at different wavelength may be used to illuminate the object or sample 12 with multiple, different wavelengths. This could be an array of LED or laser diodes with each emitting at a slightly different wavelength.

As seen in FIG. 1A, the image sensor 14 includes individual pixels 20 that have a particular pixel pitch (Δx, Δy) that generate a sensor output. The image sensor 14 may include, for example, a color CMOS sensor chip with a pixel size or pitch of less than 2 μm. These types of images sensors 14 are typically manufactured for cameras used in mobile cameras. With reference to FIG. 1C, in one embodiment, the optical fiber, optical cable, or waveguide 16 is coupled to a rotational arm or stage 22 that imparts rotational movement (in multiple axes) to the optical fiber, optical cable, or waveguide 16 so that light can illuminate the object or sample 12 at different illumination angles (θₖ, φₖ). A moveable stage 24 is also illustrated in FIG. 1C as being coupled to the sample holder 15 and/or the image sensor 14. Thus, the moveable stage 14 may be coupled to move the sample holder 15 only, the image sensor 14 only, or both. In this embodiment, the moveable stage 24 adjust the sample-to-image sensor distance zₖ between the sample holder 15 (and thus object or sample 12) and the image sensor 14. Optionally, the moveable stage 24 can also provide lateral movement (e.g., x and y shifts) of the sample holder 15 and/or image sensor 14. Alternatively, the moveable stage 24 could be coupled to the rotational arm or stage 22 to provide x, y movement to the optical fiber, optical cable, or waveguide 16. This movement causes lateral displacements between the hologram and the image sensor planes (x_{shift, k} and y_{shift, k}) and is used for sub-pixel shifts for pixel super-resolution as explained herein.

Thus, some of the controllable parameters of the imaging system are illustrated in FIGS. 1A-1C and include the illumination angle (θₖ and φₖ), wavelength λₖ, sample-to-image sensor distance zₖ, and the lateral displacements between the hologram and the image sensor planes (x_{shift, k} and y_{shift, k}). In some embodiments, one of these parameters is adjusted during imaging operations (e.g., wavelength λₖ). In other embodiments, two or more of these parameters is adjusted during imaging operations.

Still referring to FIG. 1C, the system 10 includes a computer 30 that contains software 24 loaded thereon or executable by the computer 30 to process raw images 50 that are output from the sensor output of the image sensor 14. Images 50 may be transferred to the computer 30 using a cable or they may be wirelessly transmitted to the computer 30. The software 24 includes the propagation phasor-based holographic reconstruction algorithm described herein which may be embodied in MATLAB® or other program (e.g., C language). The software 24 is executed by one or more processors 32 contained in the computer 30. To improve performance, the computer 30 may optionally include a processor 32 that is part of a graphics processing unit (GPU) to speed the image reconstruction process. The computer 30 may include a personal computer, server, laptop, or the like. The computer 30 may also be coupled to or otherwise contain a monitor 34 and one or more peripheral devices 36 (e.g., mouse, keyboard, or the like). Reconstructed images may be displayed to the user on the monitor 34.

The components of the system 10 described above may be incorporated into a small, benchtop unit that can be used to obtain high resolution images of a sample 12. In other embodiments, it may be possible to incorporate the imaging components into a small, portable device. While any type of sample 12 may be imaged using the system 10, it has particular suitability for imaging a sample 12 that includes a biological sample (e.g., bodily fluid such as blood or the like). The sample 12 may also include a pathological sample such as histological slide that may be unstained or stained depending on the particular application. The system 10 may also be used to image environmental samples containing small particulate matter or pathogens found in air or water sources.

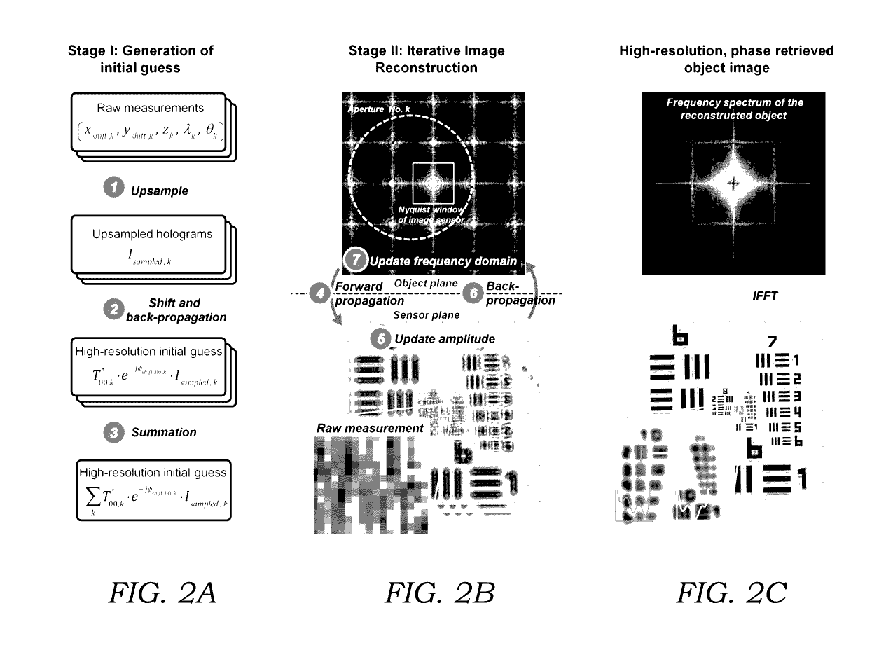

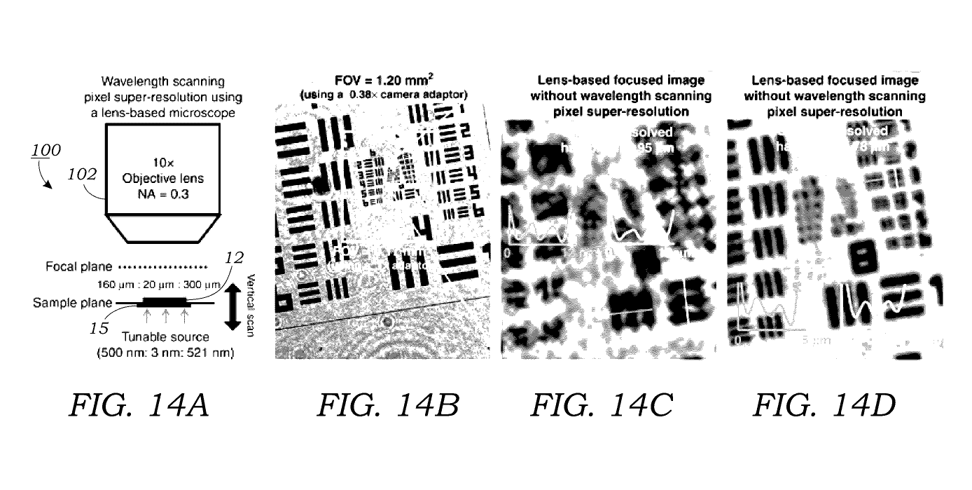

FIG. 14A illustrates an alternative embodiment of a system 100. In this embodiment, a lens-based microscope is disclosed. As seen in FIG. 14A, the sample 12 is located on a sample holder 15 and defines a sample plane. A wavelength-tunable light source 18 (or multiple different light sources emitting light at different wavelengths) is provided that is configured to illuminate the sample at a plurality of different wavelengths λₖ along an optical path that includes a lens 102 disposed therein. In the example of FIG. 14A, a 10× objective lens (NA=0.3) is illustrated although multiple lenses (e.g., a lens set) can be used. Light from the light source 18 passes through the sample holder 16 and sample 12 and enters the lens 102 (or as explained herein multiple lenses). An image sensor 14 (not shown in FIG. 14A) is configured to receive illumination passing through the sample 12 and lens 102 along the optical path, wherein the at least one of the sample holder 16, lens 102, or image sensor 14 are moveable along the optical path to introduce incremental defocusing conditions to the microscope device, wherein the image sensor obtains a plurality of images of the sample at the different wavelengths under the incremental defocusing conditions. As explained herein, the plurality of images that are obtained with the system 102 are used by software 24 executed by that at least one processor 32 to (1) generate a high-resolution initial guess of the sample image based on the plurality of images of the sample at the different wavelengths under the incremental defocusing conditions, (2) iteratively eliminate artifacts and retrieving phase information from the high-resolution initial guess of the sample image, and (3) output a high resolution, phase retrieved high resolution image of the sample 12 as illustrated in FIG. 2A.

Mathematical Formalism of Propagation Phasor Approach in Digital Holography

The concept of propagation phasors is established by deriving the analytical expressions that contain not only the holographic information of the sample 12, but also the twin image noise, spatial aliasing signal, and upsampling related spatial artifacts that are present. Throughout this analysis, plane wave illumination is assumed and it is also supported by the imaging set-up of FIGS. 1A and 1C. The transfer function of the optical system between the sample 12 and the image sensor plane can be written as hₖ(x, y, zₖ, λₖ, θₖ, φₖ), where x and y are the lateral coordinates at the sensor plane, zₖ is the vertical sample-to-image sensor distance, λₖ is the illumination wavelength, and (θₖ, φₖ) defines the angle of incidence. The subscript k denotes different imaging configurations, achieved by e.g., vertically moving the sample 12 or image sensor 14 to record the holograms at different sample-to-image sensor distances zₖ, changing the illumination wavelength λₖ, or tilting the illumination beam to change the angle of incidence, θₖ and φₖ. One additional pair of variables in the imaging configuration is the lateral displacements between the image sensor 14 and the object planes, i.e., x_{shift, k} and y_{shift, k}, as seen in FIG. 1A. Such sub-pixel displacements are utilized as one way of mitigating the spatial undersampling at the image sensor 14 due to a large pixel size.

Under these different imaging configurations, each labeled with index k, the transmission properties of a two-dimensional (2D) sample 12 can be generally expressed as oₖ(x, y)=1+sₖ(x, y), where sₖ refers to the scattered object field that interferes with the background unscattered light. The frequency spectrum Oₖ(fₓ, f_{y}) of oₖ(x, y) can be written as:

Oₖ(fₓ,f_{y})=δ(fₓ,f_{y})+Sₖ(fₓ,f_{y}) (1)

Similarly, one can write the 2D spatial frequency spectrum of the transfer function hₖ(x, y, zₖ, λₖ, θₖ) as:

Hₖ(fₓ,f_{y},zₖ,λₖ,θₖ)≡FT{hₖ(x,y,zₖ,λₖ,θₖ)} (2)

where FT refers to the Fourier Transform operation. From now on, the expressions of all the frequency spectra will be simplified in the equations by hiding the spatial frequency variables fₓ, and f_{y}. The frequency spectrum of the field intensity iₖ(x, y) on the image sensor plane can then be expressed as:

Iₖ=δ+TₖSₖ+(Tₖ⁻·Sₖ⁻)*+SSₖ (3)

where the superscript ‘−’ represents using variable set (−fₓ, −f_{y}) instead of (fₓ, f_{y}) and the asterisk stands for complex conjugate operation. SSₖ represents the self-interference terms, which can be written as SSₖ=Γ_{f}_{ₓ}_{, f}_{_{y}}{Hₖ·Sₖ(fₓ−f_{x, k}, f_{y}−f_{y, k})}, where Γ_{f}_{ₓ}_{, f}_{_{y}} refers to the autocorrelation operation. Tₖ is determined by the transfer function Hₖ, i.e.:

Tₖ=Hₖ*(f_{x,k},f_{y,k})·Hₖ(fₓ+f_{x,k},f_{y}+f_{y,k}) (4)

where f_{x, k}=nₖ sin θₖ cos φₖ/λₖ, f_{y, k}=nₖ sin θₖ sin φₖ/λₖ, and nₖ is the refractive index of the medium, which is assumed to be a function of only the illumination wavelength. It is important to notice that Hₖ is a complex function with a unit magnitude, defining a phasor. Based on Eq. (4), as a product of Hₖ*(f_{x, k}, f_{y, k}) and Hₖ, the function Tₖ is also a phasor, and the term Tₖ is deemed as a propagation phasor, the function of which in the reconstruction framework will be more clear below.

When any intensity distribution iₖ(x, y) is sampled by an image sensor 14 with a pixel pitch of Δx and Δy in lateral directions, the discrete Fourier transform (DFT) of the sensor's output can be expressed as:

$${I}_{sampled , k} = {\sum }_{u , v = 0 , \pm 1 , \pm 2 , …} {I}_{k} ( {f}_{x} - \frac{u}{Δ x} , {f}_{y} - \frac{v}{Δ y} ) \cdot {P}_{k} ( {f}_{x} - \frac{u}{Δ x} , {f}_{y} - \frac{v}{Δ y} ) \qquad ( 5 )$$

In Eq. (5) u and v are integers representing the aliasing orders, and (u, v)=(0, 0) denotes the non-aliased target signal of the object. Pₖ(fₓ, f_{y}) is the 2D FT of the pixel function that defines the responsivity distribution within each pixel of the image sensor 14. Originally, fₓ, and f_{y} in Eq. (5) are discrete frequency values confined within the Nyquist window. Based on the periodic nature of DFT, Eq. (5) and all of the further derivations can be numerically extended to a broader frequency domain by simply upsampling the raw measurements. Therefore, without change of notations, I_{sampled, k} refers to the DFT of the upsampled version of the raw measurements.

Now, the lateral displacements between the holograms and the image sensor 14 are incorporated into Eq. (5). If one adds lateral shifts (x_{shift, k}, y_{shift, k}) to each hologram, then Eq. (5) can be re-written as:

$${I}_{sampled , k} = {\sum }_{u , v = 0 , \pm 1 , \pm 2 , …} {I}_{uv , k} \cdot {P}_{uv , k} \cdot {e}^{- j {φ}_{shift , uv , k}} \qquad ( 6 )$$

where the expression of spatial aliasing order is simplified by using the subscript uv, and φ_{shift, uv, k} represents the phase change caused by a lateral shift:

$${φ}_{shift , uv , k} = 2 π [ ( {f}_{x} - \frac{u}{Δ x} ) \cdot {x}_{shift , k} + ( {f}_{y} - \frac{v}{Δ y} ) \cdot {y}_{shift , k} ] \qquad ( 7 )$$

In Eq. (6), by replacing the expression of I_{uv, k} with Eq. (3), one can obtain an expanded expression for I_{sampled, k}:

$${I}_{sampled , k} = {\sum }_{u , v = 0 , \pm 1 , \pm 2 , …} [ {δ}_{uv} + {T}_{uv , k} \cdot {S}_{uv , k} + {( {T}_{uv , k}^{-} \cdot {S}_{uv , k}^{-} )}^{*} + {SS}_{uv , k} ] \cdot {P}_{uv , k} \cdot {e}^{- j {φ}_{shift , uv , k}} \qquad ( 8 )$$

On the right side of Eq. (8), one can see that, for each aliasing order (i.e., each combination of u and v, including the target signal: u=0, v=0), there are four items inside the square brackets. The first item, δᵤᵥ, represents the background light, the second item, T_{uv, k}·S_{uv, k}, represents the real image, the third item, (T_{uv, k}⁻·S_{uv, k})*, represents the twin image; and the last item, SS_{uv, k}, is the self-interference term.

Two-Stage Holographic Reconstruction Algorithm

As explained herein, a generic, two-stage holographic reconstruction algorithm using propagation phasors is set forth which aims to recover the object term δ₀₀+S_{00, k} from a series of measured holograms.

Stage I of Propagation Phasor Based Holographic Reconstruction: Generation of an Initial Guess

With reference to FIG. 2A, the first stage of the reconstruction is to generate a high-resolution initial guess of the sample, and this Stage I is composed of three steps (i.e., Steps 1-3 in FIG. 2A).
Step 1: Upsampling of each raw measurement serves as the first step in the holographic reconstruction algorithm. This upsampling factor, although does not introduce any new information, should be large enough to expand the expression of I_{sampled, k} to cover the entire passband of the optical system. Since the computation cost of the reconstruction increases quadratically with the upsampling factor, it should also be limited to avoid unnecessary computational burden/time. For the lens-free microscopy platform reported here, a typical upsampling factor is ≦7.
Step 2: The second step of the holographic reconstruction is to offset the lateral displacements x_{shift, k}, and y_{shift, k}, and then perform back-propagation on the upsampled raw measurements. To do so, both sides of Eq. (8) are multiplied with T_{00, k}*·e^{jφshift, 00, k} and reorganize the terms to extract the true object signal, i.e., the target signal:

$$( {δ}_{00} + {S}_{00 , k} ) \cdot {P}_{00 , k} = {T}_{00 , k}^{*} \cdot {e}^{j {φ}_{shift , 00 , k}} \cdot {I}_{sampled , k} - {T}_{00 , k}^{*} \cdot {T}_{00 , k}^{- *} \cdot {P}_{00 , k} \cdot {S}_{00 , k}^{- *} - {\sum }_{u \neq 0 , v \neq 0} {T}_{00 , k}^{*} \cdot {T}_{uv , k} \cdot {e}^{j ( {φ}_{shift , 00 , k} - {φ}_{shift , uv , k} )} \cdot {P}_{uv , k} \cdot {S}_{uv , k} - {\sum }_{u \neq 0 , v \neq 0} {T}_{00 , k}^{*} \cdot {T}_{uv , k}^{- *} \cdot {e}^{j ( {φ}_{shift , 00 , k} - {φ}_{shift , uv , k} )} \cdot {P}_{uv , k} \cdot {S}_{uv , k}^{- *} - {\sum }_{u \neq 0 , v \neq 0} {T}_{00 , k}^{*} \cdot {e}^{j ( {φ}_{shift , 00 , k} - {φ}_{shift , uv , k} )} \cdot {P}_{uv , k} \cdot {δ}_{uv} - {\sum }_{u , v} {T}_{00 , k}^{*} \cdot {e}^{j ( {φ}_{shift , 00 , k} - {φ}_{shift , uv , k} )} \cdot {P}_{uv , k} \cdot {SS}_{uv , k} \qquad ( 9 )$$

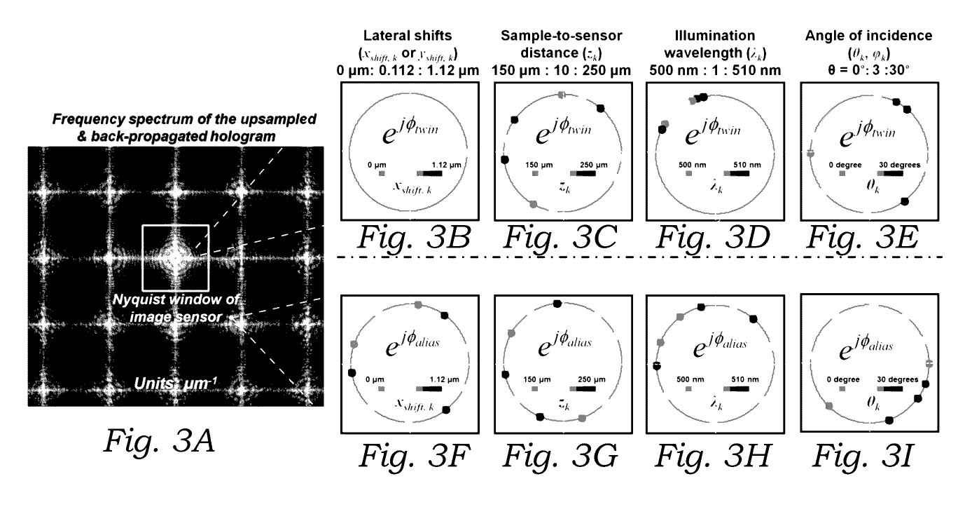

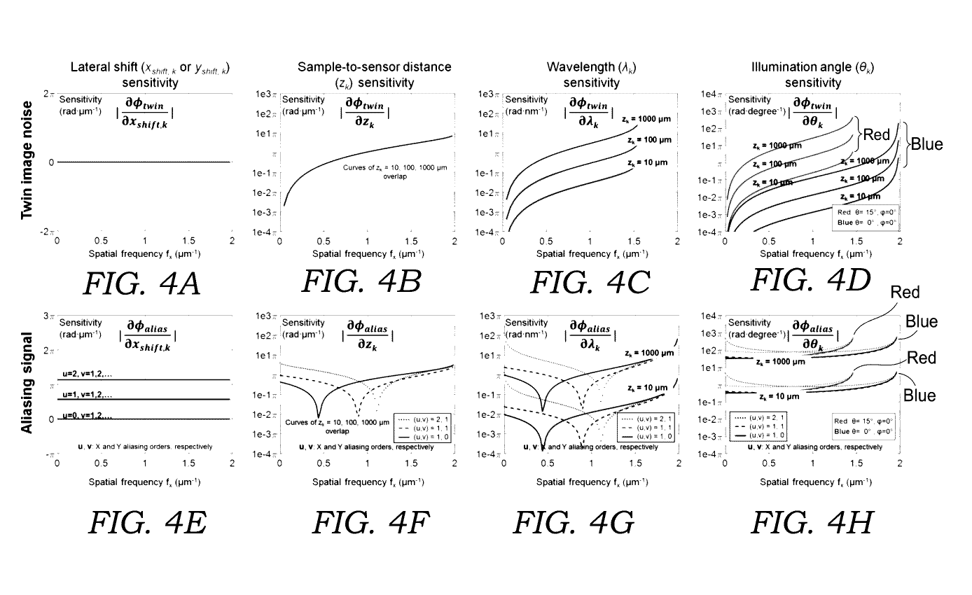

On the left side of Eq. (9), the pixel function is kept at P_{00, k} multiplied with δ_{00, k} S_{00, k}; note, however, that it can be later removed using deconvolution techniques as the last step of the holographic reconstruction. The right side of Eq. (9) shows that in order to extract (S₀₀+S_{00, k})·P_{00, k}, there are five terms that need to be eliminated from the back-propagated intensity (i.e., T_{00, k}*·e^{jφshift, 00, k}·I_{sample, k}). The first term, T_{00, k}*·T_{00, k}⁻*·P_{00, k}·S_{00, k}⁻*, represents the twin image noise; the second and third terms which contain S_{uv, k} or S_{uv, k}⁻* (u≠0, v≠0) represent the spatial aliasing signals for real and twin images, respectively; the fourth term with δᵤᵥ (u≠0, v≠0) is the high frequency artifacts generated during the upsampling process. The last term with SS_{uv, k} is the self-interference signal.
Step 3: Summation of all the upsampled and back-propagated holograms T_{00, k}*·e^{jφshift, 00, k}·I_{sampled, k} to generate an initial guess. This initial summation can greatly suppress the twin image noise, aliasing signal and other artifact terms outlined above in Step 2. To better explain the impact of this summation step, one can simplify the expression of the phasor terms in Eq. (9) as:

$$( {δ}_{00} + {S}_{00 , k} ) \cdot {P}_{00 , k} \approx {T}_{00 , k}^{*} \cdot {e}^{j {φ}_{shift , 00 , k}} \cdot {I}_{sampled , k} - {Q}_{00 , k}^{twin} \cdot {P}_{00 , k} \cdot {S}_{00 , k}^{- *} - {\sum }_{u \neq 0 , v \neq 0} {Q}_{uv , k}^{real} \cdot {P}_{uv , k} \cdot {S}_{uv , k} - {\sum }_{u \neq 0 , v \neq 0} {Q}_{uv , k}^{twin} \cdot {P}_{uv , k} \cdot {S}_{uv , k}^{- *} - {\sum }_{u \neq 0 , v \neq 0} {Q}_{uv , k}^{artifact} \cdot {P}_{uv , k} \cdot {δ}_{uv} - {\sum }_{u , v} {Q}_{uv , k}^{artifact} \cdot {P}_{uv , k} \cdot {SS}_{uv , k} \qquad ( 10 )$$

where Q_{00, k}^{twin}=T_{00, k}*·T_{00, k}⁻*, Q_{uv, k}^{real}=T_{00, k}*·T_{uv, k}·e^{j(φ}^{_{shift, 00, k}}^{-φ}^{_{shift, uv, k}}⁾, Q_{uv, k}^{twin}=T_{00, k}*·T_{uv, k}⁻*·e^{j(φ}^{_{shift, 00, k}}^{-φ}^{_{shift, uv, k}}⁾, and Q_{uv, k}^{artifact}=T_{00, k}*·e^{j(φ}^{_{shift, 00, k}}^{-φ}^{_{shift, uv, k}}⁾. Here Q_{00, k}^{twin}, Q_{uv, k}^{real}, Q_{uv, k}^{twin} and Q_{uv, k}^{artifact} are also phasors with unit amplitudes, and their phases change as a function of all the imaging parameters (i.e., zₖ, λₖ, θₖ, φₖ, x_{shift, k}, and y_{shift, k}), see e.g., FIGS. 3B-3I and 4A-4H.

Also notice that except the illumination wavelength λₖ, the changes of the imaging parameters zₖ, θₖ, φₖ, x_{shift, k}, and y_{shift, k} do not affect the transmission properties of the 2D sample. During the imaging process, the illumination wavelengths are confined within a narrow spectral range, typically less than 10 nm, so that the transmission properties of the sample and the image sensor's pixel function can be approximately considered identical when generating an initial guess of the object, i.e., S_{uv, k}≈Sᵤᵥ, and P_{uv, k}≈Pᵤᵥ. If one lists Eq. (10) for all the possible K imaging conditions (e.g., as a function of various illumination wavelengths, sub-pixel shifts, etc.), and then sum them up with a set of weighting factors, {cₖ}, this produces:

$$( {\sum }_{k = 1}^{K} {c}_{k} ) ( {δ}_{00} + {S}_{00} ) \cdot {P}_{00} \approx {\sum }_{k = 1}^{K} {c}_{k} \cdot {T}_{00 , k}^{*} \cdot {e}^{j {φ}_{shift , 00 , k}} \cdot {I}_{sampled , k} - ( {\sum }_{k = 1}^{K} {c}_{k} \cdot {Q}_{00 , k}^{twin} ) \cdot {P}_{00} \cdot {S}_{00}^{- *} - {\sum }_{u \neq 0 , v \neq 0} ( {\sum }_{k = 1}^{K} {c}_{k} \cdot {Q}_{uv , k}^{real} ) \cdot {P}_{uv} \cdot {S}_{uv} - {\sum }_{u \neq 0 , v \neq 0} ( {\sum }_{k = 1}^{K} {c}_{k} \cdot {Q}_{uv , k}^{twin} ) \cdot {P}_{uv} \cdot {S}_{uv}^{- *} - {\sum }_{u \neq 0 , v \neq 0} ( {\sum }_{k = 1}^{K} {c}_{k} \cdot {Q}_{uv , k}^{artifact} ) \cdot {P}_{uv} \cdot {δ}_{uv} - {\sum }_{u , v} ( {\sum }_{k = 1}^{K} {c}_{k} \cdot {Q}_{uv , k}^{artifact} \cdot {S}_{uv , k} ) \cdot {P}_{uv} \qquad ( 11 )$$

By finding a set of weighting factors {cₖ} that satisfy

$${\sum }_{k = 1}^{K} {c}_{k} \cdot {Q}_{uv , k}^{twin} = 0 ( u , v = 0 , \pm 1 , \pm 2 , … ) ;$$

$${\sum }_{k = 1}^{K} {c}_{k} \cdot {Q}_{uv , k}^{real} = 0 ( u \neq 0 , v \neq 0 ) ;$$

$${\sum }_{k = 1}^{K} {c}_{k} \cdot {Q}_{uv , k}^{artifact} = 0 ( u \neq 0 , v \neq 0 ) ; and$$

$${\sum }_{k = 1}^{K} {c}_{k} \neq 0 ,$$

one can have “complete elimination” of the twin image noise, aliasing signals and upsampling related spatial artifacts, while still maintaining the target object function, (δ₀₀+S₀₀)·P₀₀. However, considering the fact that Q_{uv, k}^{twin}, Q_{uv, k}^{real} and Q_{uv, k}^{artifact} are also functions of spatial frequencies (fₓ, f_{y}), it is computationally expensive to obtain a set of ideal {cₖ} values. Therefore, an alternative strategy is adopted as shown in FIG. 2A to create the initial object guess and set all {cₖ} values to 1, and directly sum up the upsampled and back-propagated holograms, T_{00, k}*·e^{jφshift, 00, k}·I_{sampled, k}. After this summation, the left side of Eq. (11) becomes K·(δ₀₀+S₀₀·P₀₀), while on the right side, the summations of the phasors Q_{uv, k}^{twin}, Q_{uv, k}^{real} and Q_{uv, k}^{artifact} follow:

$$\vert {\sum }_{k = 1}^{K} {Q}_{uv , k}^{twin} \vert \leq K , \vert {\sum }_{k = 1}^{K} {Q}_{uv , k}^{real} \vert \leq K , \vert {\sum }_{k = 1}^{K} {Q}_{uv , k}^{artifact} \vert \leq K \qquad ( 12 )$$

In fact, as illustrated in FIGS. 3A-3I, with proper selection of the imaging configuration, the summations of these phasors can be significantly smaller than K. This implies that, by simply summing up Eq. (11) for all K imaging configurations, the twin image noise (S₀₀⁻*), aliasing signals (S_{uv, k} and S_{uv, k}⁻*, u≠0, v≠0) and upsampling related artifacts (Q_{uv, k}^{artifact}) be significantly suppressed in comparison with the target signal (δ₀₀+S₀₀)·P₀₀. Therefore, a simple summation is considered as a good initial guess of the sample at this Stage I of the propagation phasor based holographic reconstruction approach, i.e.,

$$( {δ}_{00} + {S}_{00 , initial} ) \cdot {P}_{00} ≡ \frac{1}{K} {\sum }_{k = 1}^{K} {T}_{00 , k}^{*} \cdot {e}^{j {φ}_{shift , 00 , k}} \cdot {I}_{sampled , k} \qquad ( 13 )$$

This initial guess is then used as the input to an iterative algorithm (Stage II) to reconstruct and refine the object function/image, which will be detailed below.

Stage II of Propagation Phasor Based Holographic Reconstruction: Iterative Image Reconstruction

Using the initial guess defined by Eq. (13), an iterative process is then implemented as the second stage of the propagation phasor based holographic reconstruction algorithm to eliminate the remaining twin image noise, aliasing signal, and the upsampling related artifacts. Each iteration of Stage II is comprised of four steps (i.e., Steps 4 through 7—see FIG. 2B):
Step 4: Based on the parameters of each illumination condition, (i.e., zₖ, λₖ, θₖ, φₖ), a phase modulation is applied on the initial guess of the sample, defined by Eq. (13), and propagate the field from the object plane to the image sensor using the angular spectrum approach as described in Goodman, J. Introduction to Fourier Optics. (Roberts and Company Publishers, 2004), which is incorporated by reference herein. For this wave propagation, the free space transfer function is used:

$${H}_{k} ( {f}_{x} , {f}_{y} ) = \{ \begin{matrix}exp [ j 2 π \frac{{n}_{k} \cdot {z}_{k}}{{λ}_{k}} \sqrt{1 - {( \frac{{λ}_{k}}{{n}_{k}} {f}_{x} )}^{2} - {( \frac{{λ}_{k}}{{n}_{k}} {f}_{y} )}^{2}} ] & ( {f}_{x}^{2} + {f}_{y}^{2} \leq {( \frac{{n}_{k}}{{λ}_{k}} )}^{2} ) \\ 0 & else\end{matrix} \qquad ( 14 )$$

Wave propagation from the object plane to the image sensor is deemed as forward-propagation, and the spatial form of the forward-propagated field is denoted as g_{forward, k}(x, y).
Step 5: On the image sensor plane, the raw measurements (i.e., the low-resolution, undersampled holograms) are used to update the amplitude of the high-resolution, forward-propagated field δ_{forward, k}(x, y). To do so, one first convolves the intensity of the field, |δ_{forward, k}(x, y)|², with the pixel function of the image sensor, and shift the convolved intensity by an amount of (x_{shift, k}, y_{shift, k}) to compensate the corresponding lateral displacement. Next, this shifted intensity is downsampled to the same resolution as the raw measurement, and the difference between this downsampled intensity and the raw measurement is considered as a low-resolution correction map. In order to apply this low-resolution correction map to each shifted intensity, this correction map is upsampled by taking its Kronecker product with the pixel function, and added the upsampled correction map to the shifted intensity with a relaxation factor (typically ˜0.5). Then this ‘corrected’ intensity is deconvolved with the pixel function using Wiener deconvolution, and shifted back in place by the amount of (−x_{shift, k}, −y_{shift, k}). The Wiener filter takes into account the measured noise level of the image sensor to avoid over-amplification of noise during each iteration. One then uses the square root of the deconvolved and shifted intensity to replace the amplitude of g_{forward, k}(x, y), while keeping its phase unaltered.
Step 6: Back-propagate the amplitude-updated, high-resolution field to the object plane, and remove the phase modulation caused by the illumination angle.
Step 7: The back-propagated field is then used to update the transmitted field on the object plane. This is different from Step 6; as this update on the object plane is carried out in the spatial frequency domain. The spatial frequency region for this update is a circular area centered at f_{x, k}=nₖ·sin θₖ·cos φₖ/λₖ, f_{y, k}=nₖ·sin φₖ sin φₖ/λₖ, and the radius of the circle is chosen so that all the spatial frequencies within it experience less than 3 dB amplitude attenuation during wave propagation. This update in the spatial frequency domain is also smoothened using a relaxation factor of ˜0.5. In other words, the updated frequency region is the weighted sum of the old transmitted field and the back-propagated field, and the weighting factor (i.e., relaxation factor) for the back-propagated field is ˜0.5. After this update, the phase of the field is converted into an optical path length map of the object, and the amplitude of the field gives the object's final transmission image, i.e., reconstruction. FIG. 2C illustrates an Inverse Fast Fourier Transform (IFFT) used to convert the image from the frequency domain. Note that for relatively thick sample (e.g., thick tissue specimen), phase unwrapping needs to be performed before converting the reconstructed phase into an optical path length. Details regarding phase unwrapping may be found in Luo, W. et al. Wavelength scanning achieves pixel super-resolution in holographic on-chip microscopy, SPIE BiOS 9699-9 (2016), which is incorporated herein by reference.

These above outlined steps (Steps 4 to 7) are performed for every imaging configuration. It is considered as one iteration cycle when all the K raw measurements are used for once. Similar to the convergence condition defined in Allen, L. J. et al., Exit wave reconstruction at atomic resolution. Ultramicroscopy 100, 91-104 (2004), which is incorporated by reference, the convergence of the iterations and the reconstruction is determined when the sum-squared error (SSE_{avg}^{itr}) between the raw measurement and the downsampled intensity map satisfies the following criterion:

|SSE_{avg}^{itr}−SSE_{avg}^{itr-1}|<ε (15)

where ‘itr’ is the index of the iteration cycle, and e is the convergence constant, empirically defined as ˜0.2% of SSE_{avg}^{itr}.

### EXPERIMENTAL

To demonstrate the propagation phasor approach for holographic image reconstruction, it was implemented using lens-free holographic microscopy although it is broadly applicable to other holographic microscopy platforms (including those with lenses). As depicted in FIGS. 1B and 1C, the lens-free holographic microscope includes three parts: a fiber-coupled wavelength-tunable light source (WhiteLase-Micro, model VIS, Fianium Ltd, Southampton, UK), an image sensor chip (IU081, Sony Corporation, Japan), and a thin sample mounted above the sensor chip. The optical fiber's outlet that is used to illuminate the sample is placed at e.g. ˜10 cm away from the sample whereas the sample-to-image sensor distance is typically 0.1-1 mm and thus the illumination at the object plane can be considered as a plane wave. By bringing sample close (sub-mm) to the image sensor, lens-free on-chip holography allows the utilization of the image sensor active area as the object field-of-view, creating a unit magnification in-line holographic imaging system, where the spatial resolution and field-of-view can be independently controlled and adjusted by the pixel design and the number of pixels, respectively. The fiber optic cable was mounted on a rotational arm (PRM1Z8, Thorlabs, New Jersey, USA) so that it can move across a three-dimensional dome-shaped surface above the sample so that the incident light can also be adjusted to an arbitrary angle. In the experimental configuration, the rotational arm was further loaded on a mechanical linear stage that moves in lateral directions to introduce sub-pixel displacements (x, y direction) between the hologram and the image sensor-array. The specimen is held by a piezo-driven positioning stage (MAX606, Thorlabs, New Jersey, USA), which can move vertically to change the distance between the sample and the image sensor chip (z direction). During the holographic data acquisition, the tunable source, the mechanical stages, and the image sensor chip are all automated and coordinated by a PC running a custom-written LabVIEW program (Version 2011, National Instruments, Texas, USA).

Sample Preparation

Besides a standard 1951 USAF resolution test target, the propagation phasor approach was also tested by imaging biological samples, including unstained Papanicolaou (Pap) smear slides and blood smears. Pap smears are prepared using ThinPrep® method (Hologic, Massachusetts, USA). The blood smear samples are prepared using EDTA (ethylenediaminetetraacetic acid) anticoagulated human blood and stained with Wright's Stain.

Computation Platform Used for Propagation Phasor Based Holographic Reconstructions

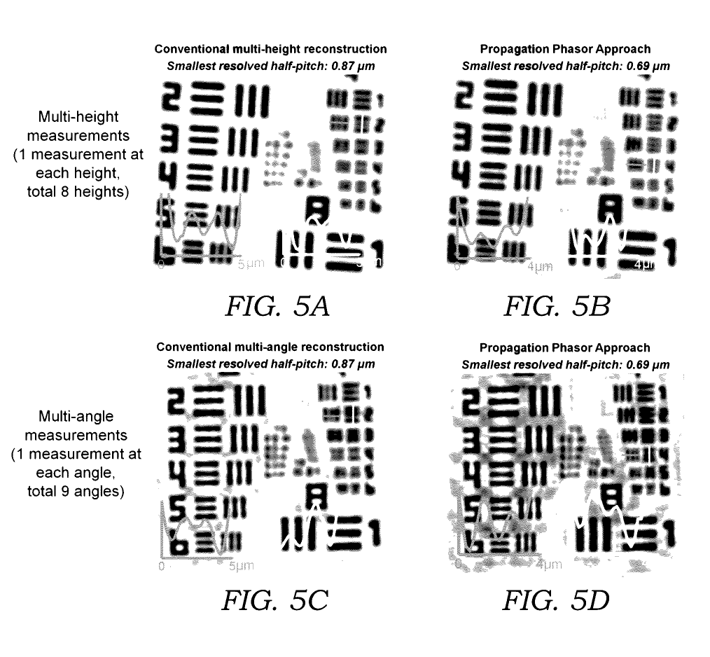

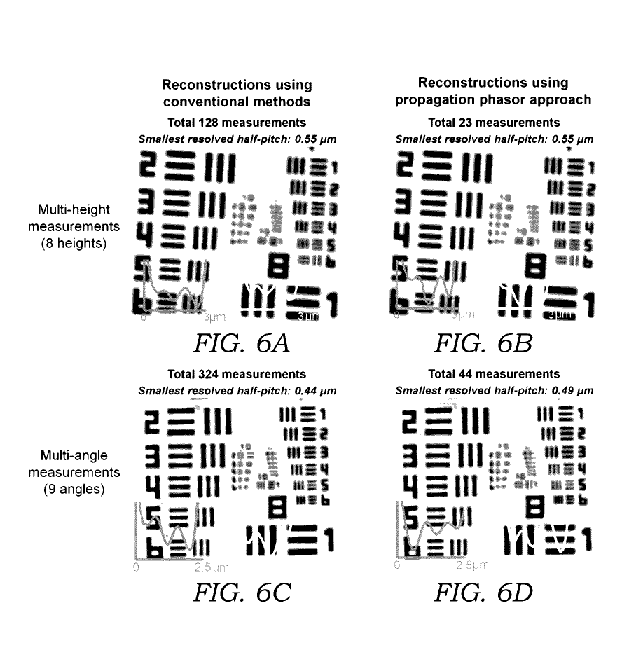

For proof-of-concept implementation, the propagation phasor approach based reconstruction algorithm has been implemented using MATLAB® (Version R2012a, MathWorks, Massachusetts, USA) on a desktop computer with 3.60-GHz central processing unit (Intel Xeon ES-1620) and 16 GB random-access memory. Of course, dedicated imaging software or other programs may be used besides MATLAB®. Using an upsampling factor of seven, the computation time of one iteration in reconstruction Stage II is ˜1.2 seconds for a region-of-interest of ˜1×1 mm². As for the total computation time including Stages I and II, assuming that the number of intensity distribution updates is ˜8-10 per iteration (see e.g. FIGS. 5B, SD and FIGS. 6B, 6D), and that the convergence can be reached within ˜6-7 iteration cycles, the total image reconstruction time ranges between ˜1-1.5 minutes per 1 mm². More than 85% of this computation time is spent on wave propagation between the sample and the image sensor planes, which heavily relies on Fast Fourier Transforms (FFTs). Therefore, the adoption of graphic processing units (GPUs) or other parallel computing architectures could significantly reduce the total computation time.

Results and Discussion

The main challenges of wide field-of-view, high-resolution holographic imaging include: (1) phase retrieval, and (2) mitigating the undersampling caused by an image sensor chip. The propagation phasor approach described herein relies on the fact that in the digital hologram of a sample, the twin image noise and spatial aliasing signals vary under different imaging configurations. Such variations enable one to eliminate these unwanted noise terms (twin image noise and aliasing signal) and obtain phase-retrieved and high-resolution (i.e., super-resolved) reconstructions of the object. The imaging configuration in a holographic microscope can in general be changed by varying different parameters: (1) the lateral displacements between the holograms and the sensor-array (i.e., lateral relative shifts x_{shift, k} and y_{shift, k}), (2) the sample-to-image sensor distance (zₖ), (3) the illumination wavelength (4), and (4) the angle of incidence (θₖ, φₖ).

To better illustrate the inner workings of the propagation phasor approach, the dependencies of the twin image noise and the aliasing signal on these controllable imaging parameters are demonstrated followed by a summary of the combinations of these imaging parameters that can create phase-retrieved and high-resolution reconstructions while also improving the data efficiency of holographic imaging.

Dependency of Twin Image Noise and Aliasing Signal on Imaging Parameters

From Eq. (10), one can see that all the terms which need to be eliminated from an upsampled and back-propagated hologram T_{00, k}*·e^{jφshift, 00, k}·I_{sampled, k} are modulated by phasors, including: (1) the twin image term, modulated by Q_{00, k}^{twin}; (2) aliasing signals, modulated by Q_{uv, k}^{real} and Q_{uv, k}^{twin}, u≠0, v≠0; (3) upsampling artifacts (δᵤᵥ terms modulated by Q_{uv, k}^{artifact}, u≠0, v≠0; and (4) self-interference patterns (SS_{uv, k} terms modulated by Q_{uv, k}^{artifact}). From the perspective of the propagation phasor approach, it is desirable that the phasors that modulate these unwanted noise terms or artifacts exhibit sufficient variations across [0, 2π], so that they can be significantly suppressed during the initial summation in the reconstruction Stage I. Here, the focus of the discussion is on twin image phasor Q_{00, k}^{twin} and aliasing related phasors Q_{uv, k}^{real}, Q_{uv, k}^{twin}, (u≠0, u≠0), where the conclusions would be broadly applicable to a wide range of holographic imaging systems (lens-based or lens-free). Meanwhile, the self-interference patterns/artifacts are much weaker in signal strength compared to the holographic interference terms and can be easily suppressed by the iterative reconstruction algorithm (Stage II).

To illustrate the dependencies of the twin image noise and the aliasing signal on the holographic imaging parameters, the twin image phasor e^{jφtwin}≡Q_{00, k}^{twin} and one of the spatial aliasing phasors, i.e., e^{jφalias}≡Q_{uv, k}^{real} (u=1, v=1) were chosen as examples. FIGS. 3A-3I is a visualization of these phasors as a function of the imaging parameters (x_{shift, k, shift, k}, zₖ, λₖ, θₖ, and φₖ). In each panel image of FIGS. 3B-3I, only one of the imaging parameters is changed while keeping all the others constant. For instance, in FIG. 3B that shows e^{jφtwin}, only the lateral shift x_{shift, k} was changed from 0 μm to 1.12 μm (i.e., the pixel pitch of the image sensor chip used in our experiments) with a step size of ˜0.11 μm, while the other parameters are fixed at zₖ=150 μm, λₖ=500 nm, θₖ=0°, and φₖ=0°. Similarly, FIG. 3C through FIG. 3E depicts e^{jφtwin} as a function of zₖ, λₖ, and θₖ separately, while FIGS. 3G through 3I depicts e^{jφalais} as a function of x_{shift, k}, zₖ, λₖ, and θₖ, respectively.

From FIGS. 3B-3I, one can see that, except the twin image phasor's insensitivity to lateral shifts (FIG. 3B), the diversity of all the other imaging parameters can cause both the twin image phasor and the aliasing phasors to be modulated. To better illustrate these phasors' sensitivities to various imaging parameters, the partial derivatives of φ_{twin} and φₐₗᵢₐₛ with respect to x_{shift, k}, x_{shift, k}, zₖ, λₖ, θₖ, and φₖ were calculated as seen in FIGS. 4A-4H. These partial derivatives along the f, axis (i.e., f_{y}=0) are analyzed below with a summary of each imaging parameter's effect on φ_{twin} and φₐₗᵢₐₛ illustrated in FIGS. 4A-4H.

Lateral Shifts (x_{shift, k}, y_{shift, k}):

Since the twin image phasor e^{jφtwin}≡Q_{00, k}^{twin}≡T_{00, k}*·T_{00, k}⁻* (see Eq. 4) does not contain variables x_{shift, k} or y_{shift, k}, the absolute value of its partial derivatives with respect to x_{shift, k} and y_{shift, k} is zero, i.e., |∂φ_{twin}/∂x_{shift, k}|=0 and |∂φ_{twin}/∂y_{shift, k}|=0 (FIG. 4A). In other words, lateral shifts do not introduce any variations in the twin image noise term as a result of which they are not directly useful for twin image elimination or phase retrieval. On the other hand, as illustrated in FIG. 4E, when spatial aliasing exists in either x or y direction (i.e., u≠0, v≠0), this produces |∂φₐₗᵢₐₛ/∂x_{shift, k}|>0 and |∂φₐₗᵢₐₛ/∂y_{shift, k}|>0, which suggests that x_{shift, k} and y_{shift, k} introduce linear phase modulations (see Eq. 7) in the spatial aliasing phasor term. This linear relationship between φₐₗᵢₐₛ and (x_{shift, k}, y_{shift, k}) makes the lateral shifts ideal choice for aliasing signal elimination. If one sets the lateral shifts to be evenly distributed within one pixel pitch, where x_{shift, k}ε{m/(M·Δx)|m=1, 2, . . . M} and y_{shift, k}ε{n/(N·Δy)|n=1, 2, . . . N}, summing up the upsampled and back-propagated holograms (i.e., Stage I of the reconstruction algorithm) can lead to complete elimination of the aliasing signals. This summation is mathematically equivalent to back-propagating the pixel super-resolved holograms. To conclude, the diversity of the lateral shifts can only contribute to the aliasing signal elimination, i.e., pixel super-resolution.

Sample-to-Image Sensor Distance (zₖ):

Using the diversity of the sample-to-image sensor distance (zₖ) to eliminate the twin image noise has been one of the most widely-used phase retrieval techniques in holographic image reconstruction. For completeness, here the effect of zₖ on the twin image noise is analyzed from the perspective of the propagation phasor approach. As shown in FIG. 4B, |∂φ_{twin}/∂zₖ| rises as spatial frequency fₓ increases. Except at very low spatial frequencies (e.g., |fₓ|<0.1 μm⁻¹), φ_{twin} exhibits strong sensitivity to zₖ. For example, even at |fₓ|≈0.1 μm⁻¹, changing the sample-to-image sensor distance by ˜100 μm can make the twin image phasor e^{jφ}^{_{twin}} reverse its polarity. This sensitivity makes zₖ a very useful variable for twin image noise elimination. For aliasing signal elimination, as depicted in FIG. 4F, one can see that φₐₗᵢₐₛ also shows a good sensitivity to zₖ, i.e. |∂φₐₗᵢₐₛ/∂zₖ|≧0.01 π·μm except for a very limited number of spatial frequency points. Therefore, besides twin image elimination, the diversity of zₖ can also be used for aliasing signal elimination.

Wavelength (λₖ):

The diversity of illumination wavelength can be used for twin image elimination (i.e., phase retrieval). As shown in FIG. 4C and FIG. 4G, one important property of |∂φ_{twin}/∂λₖ| and ∂φₐₗᵢₐₛ/∂λₖ| is that they show strong dependencies on the illumination wavelength only when the sample-to-image sensor distance zₖ is large enough (e.g., zₖ>˜100 μm). Stated differently, by changing the illumination wavelength λₖ, the holographic interference patterns at the sensor-array will surely vary, but such variations become more pronounced and useful at larger distances, zₖ. Therefore, in a point-to-point focused imaging system (using e.g., a lens-based imaging set-up), the diversity of wavelength is of no use for phase retrieval or resolution enhancement unless a slight defocus (i.e., zₖ) is introduced in the imaging system.

Angle of Incidence (θₖ, φₖ):

As shown in FIGS. 4D, and 4H, similar to the case of wavelength diversity, to make use of the illumination angle for phase retrieval and elimination of aliasing signal, sufficient sample-to-image sensor distance (e.g., zₖ>100 μm) is needed. FIG. 4D also suggests that, for phase retrieval, relatively large angular variations (e.g., Δθ>10° are preferred since |∂φₐₗᵢₐₛ/∂θₖ|>0.1π·degree⁻¹. Another important observation from FIG. 4H is that at different illumination angles θₖ, |∂φₐₗᵢₐₛ/∂θₖ| remains non-zero in most of the spatial frequencies, which is similar in behavior to |∂φₐₗᵢₐₛ/∂x_{shift, k}| as shown in FIG. 4E. Intuitively, this implies that slight perturbations on the illumination angle will introduce lateral shifts of the interference patterns on the image sensor plane, which can be considered as one method of generating x_{shift, k}, and y_{shift, k}. In fact, shifting the light source by small amounts has been proven as an effective way of performing lateral shift-based pixel super-resolution in lens-free holography. Regarding the parameter φₖ, although not depicted in FIG. 4A-4H, it is important to emphasize that |∂φ_{twin}/∂φₖ|=0 and |∂φₐₗᵢₐₛ/∂φₖ|=0 when θₖ=0, and that the sensitivity of both φ_{twin} and φₐₗᵢₐₛ to φₖ increases with θₖ. Therefore, both θₖ and φₖ can be used for the elimination of twin image noise and spatial aliasing signal.

The propagation phasor approach described herein: (1) provides a unique mathematical formalism that combines/merges various existing phase retrieval and pixel super-resolution techniques used in digital holography into the same unified framework, and (2) creates two new techniques to eliminate the aliasing signal in digital holography, namely using the diversity of the sample-to-image sensor distance, and the diversity of the illumination angle. For consistency with the previous used terminology, these two new methods are called multi-height based pixel super-resolution and multi-angle based pixel super-resolution, respectively.

Propagation Phasor Approach Using Multi-Height and Multi-Angle Holographic Data

Using this new propagation phasor based reconstruction framework, the diversities of sample-to-image sensor distance or illumination angle can enable not only twin image elimination, but also resolution enhancement, i.e., super-resolution. To demonstrate the resolution enhancement brought by the diversity of zₖ (i.e., multi-height based pixel super-resolution), holograms of a standard resolution test target were captured at eight different heights, where the values of zₖ are evenly distributed between 200 μm and 305 μm with a spacing of ˜15 μm. For comparison, the sample was first reconstructed using a previous technique: multi-height based phase retrieval algorithm as seen in FIG. 5A. For the same set of raw data, this previous technique was compared to the propagation phasor based reconstruction which was found to deliver a half-pitch resolution improvement from ˜0.87 μm to 0.69 μm, corresponding to a numerical aperture (NA) improvement from 0.3 to 0.4 (wavelength: 530 nm) as seen in FIG. 5B.

In addition to multi-height based pixel super-resolution, a similar resolution enhancement can also be achieved using the diversity of illumination angles (i.e., multi-angle based pixel super-resolution). As shown in FIGS. 5C and 5D, multi-angle pixel super-resolution was demonstrated using the data captured from nine (9) different illumination angles, where one angle is vertical (0°), and rest of the angles are placed at ±15° and ±30° along two axes above the sample (see FIG. 1B). The half-pitch resolution improvement brought by the diversity of illumination angle is also similar: from ˜0.87 μm down to 0.69 μm.

Improving the Data Efficiency in High-Resolution Holographic Reconstructions Using the Propagation Phasor Approach

It was also found that much higher resolution images can be reconstructed using the propagation phasor approach by simply adding lateral shift based pixel super resolution to only one of the measurement heights or angles, which is used as an initial guess at Stage I of the reconstruction algorithm. This approach is also quite efficient in terms its data requirement compared to existing approaches.

Using the multi-height imaging configuration outlined earlier, a 4×4 lateral shift-based pixel super-resolution was performed at only one sample-to-image sensor distance (i.e., 190 μm), which added fifteen (15) extra raw measurements/holograms to the original data set that is composed of measurements at eight (8) heights. In the propagation phasor based reconstruction, the back-propagation of this super-resolved hologram at this height (190 μm) was used as the initial guess (Stage I of algorithm). The resolution improvement that were obtained by using these additional fifteen (15) raw measurements in the propagation phasor approach is significant: a half-pitch resolution of ˜0.55 μm (corresponding to an NA of ˜0.48 at 530 nm illumination) was achieved, which is the same level of resolution that is achieved by performing lateral shift-based super-resolution at every height (see FIG. 6A and FIG. 6B). In other words, to achieve the same resolution level, the propagation phasor approach utilized 5.5-fold less number of raw measurements (i.e., 23 vs. 128) compared to the conventional lateral shift-based multi-height method.

A similar level of improvement in data efficiency of the propagation phasor approach is also observed in the multi-angle imaging configuration: by simply performing 6×6 pixel super-resolution at only the vertical illumination, the propagation phasor based reconstruction can achieve a half-pitch resolution of ˜0.49 μm (corresponding to an NA of ˜0.53 at 530 nm illumination). As a comparison, the synthetic aperture approach achieves a half-pitch resolution of ˜0.44 μm; however it uses 6×6 pixel super-resolution at every illumination angle (FIG. 6C), and therefore the propagation phasor approach (FIG. 6D) has 7-fold improvement in its data efficiency (i.e., 44 vs. 324 raw measurements). This improvement and significant reduction in the number of raw measurements/holograms are especially important to make wide-field, high-resolution holographic imaging suitable for high speed applications.

Imaging Biological Samples Using the Propagation Phasor Approach

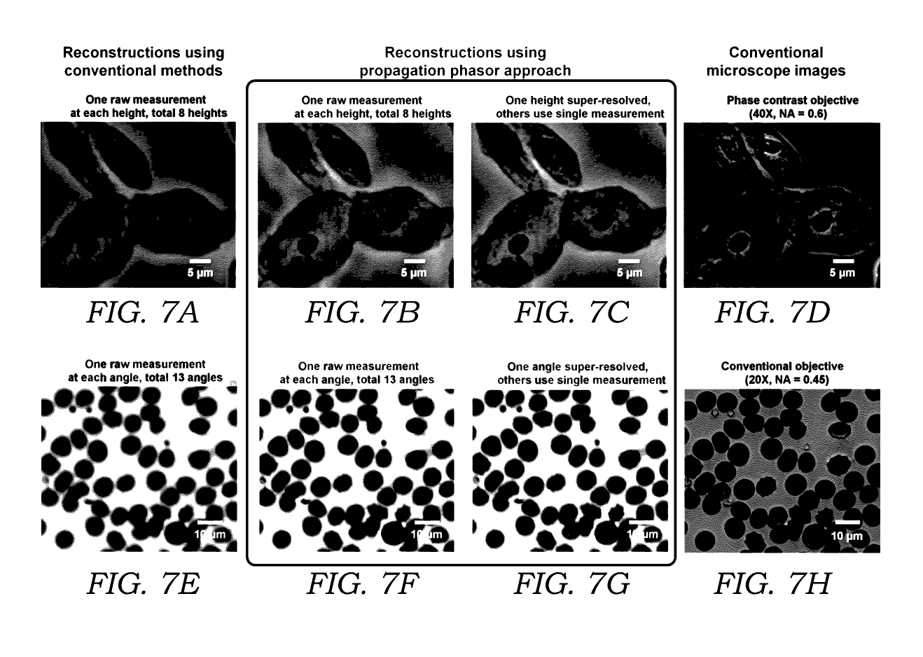

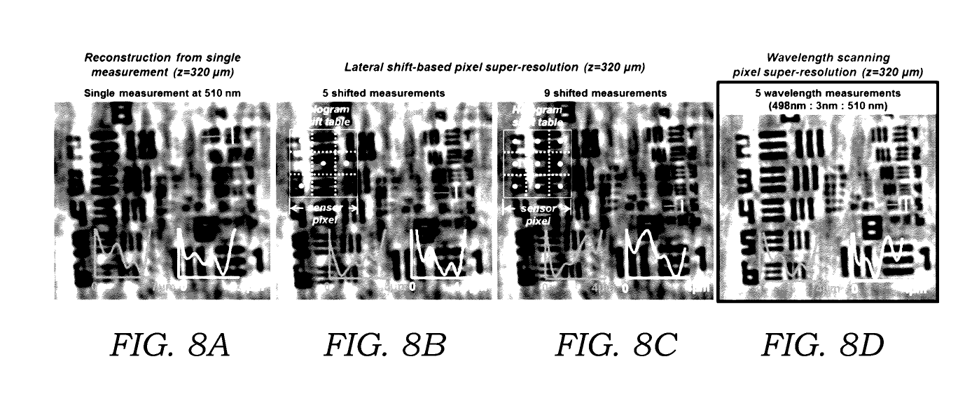

To demonstrate the success of the propagation phasor approach in imaging a biological sample, unstained Papanicolaou (Pap) smears were imaged (see FIGS. 7A-7D-d) and stained blood smears (see FIGS. 8E-8H). For Pap smear imaging, the holograms of the sample were captured at multiple sample-to-image sensor distances, and at each zₖ, only one raw measurement is recorded. For comparison, the Pap smear was first reconstructed using a previously reported multi-height phase retrieval algorithm (FIG. 7A). Using the same holographic data set and raw measurements, the reconstructions created by the propagation phasor approach (FIG. 7B) show resolution improvements compared to the previously reported method. To further improve the resolution without significantly increasing the burden of data acquisition, eight extra raw measurements were added for shift-based pixel super-resolution (with a super-resolution factor of 3×3) at only one of the heights, which is used as an initial guess (in Stage I) of the reconstruction algorithm. As shown in FIG. 7C, the propagation phasor approach based reconstruction shows a good agreement with the images captured using a conventional phase contrast microscope (40× objective lens, NA=0.6). For imaging of stained blood smears, lens-free holograms were captured at multiple illumination angles. The comparison between FIG. 7E (prior reconstruction) and FIG. 7F (propagation phasor approach) also confirms the resolution improvement brought by the propagation phasor based reconstruction algorithm. By adding lateral shift-based pixel super-resolution (with a super-resolution factor of 3×3) at only the vertical illumination angle (i.e., θₖ=0), the resolution of the reconstructed image (FIG. 7G) was further improved, which shows comparable performance against a bright-field microscope with a 40× objective lens (NA=0.6), FIG. 7H.

Based on these results, it can be seen that the propagation phasor approach would greatly increase the speed of high-resolution and wide-field holographic microscopy tools. In previously reported holographic imaging modalities, multiple laterally shifted images are captured to achieve pixel super-resolution at every one of the sample-to-image sensor distances or illumination angles. As demonstrated in FIGS. 6A-6D and FIGS. 7A-7H, the propagation phasor approach can reduce the number of required raw holograms by five to seven fold while also achieving a competitive resolution. This reduction in raw data also lowers the need for data transmission and storage, which could further improve the cost-effectiveness of holographic imaging modalities such as handheld lens-free microscopy tools for telemedicine applications. Although the experimental results obtained herein utilized a lens-free on-chip imaging set-up, it should be emphasized that this propagation phasor approach is broadly applicable to a wide range of holographic imaging modalities, including lens-based holographic microscopy techniques. For instance, in a lens-based undersampled holographic imaging system, multi-height pixel super-resolution can simply be achieved by capturing a series of defocused images at different heights. Considering the fact that the depth focusing operation is naturally required and performed every time a sample is loaded onto a lens-based traditional microscope, this propagation phasor approach provides a unique method to enlarge the space-bandwidth-product of the final image without compromising the image acquisition time.

Wavelength-Scanning Pixel Super-Resolution

In this particular embodiment, pixel super-resolution is achieved that utilizes wavelength scanning to significantly improve the resolution of an undersampled or pixelated imaging system, without the use of any lateral shifts or displacements. In this technique, the sample is sequentially illuminated at a few wavelengths that are sampled from a rather narrow spectral range of 10-30 nm (although a larger wavelength range may also be used in some embodiments). Compared with sub-pixel displacement or lateral shift-based super-resolution techniques, wavelength scanning introduces a uniform resolution improvement across all the directions on the sample plane and requires significantly fewer raw measurements to be made. Making fewer measurements without sacrificing performance could greatly benefit high-speed wide-field imaging, field-portable microscopy and telemedicine applications, which are all sensitive to data transmission and storage.

Mathematical Formalism of Wavelength-Scanning Pixel Super-Resolution

An assumption is made that the sample is a thin object mounted on a plane parallel to the image sensor chip and that the sample is sequentially illuminated by multiple wavelengths {λₖ}. At a given wavelength λₖ, the object wave can be written as oₖ(x, y)=1+sₖ(x, y), where sₖ(x, y) represents the scattered object wave, immediately at the exit of the object plane (z=0). The 2D Fourier transform of oₖ(x, y) can be written as Oₖ(fₓ, f_{y})=δ(fₓ, f_{y})+Sₖ(fₓ, f_{y}). At the image sensor plane (z=z₀), the Fourier transform of the intensity distribution, iₖ(x, y), can be written as Equation (3), above. On the right-hand side of Eq. (3), the first item, δ, represents the background intensity; the second and third items are conjugate holographic terms, which represent the interference of the scattered object wave with the background wave at the sensor plane. The fourth item is the self-interference term, which can be considered negligible for weakly scattering objects. The expression for Tₖ can be written as follows:

Tₖ(fₓ,f_{y})=Hₖ*(f_{x,k},f_{y,k})·Hₖ(fₓ+f_{x,k},f_{y}+f_{y,k}) (16)

where Hₖ(fₓ, f_{y}) is the free space transfer function, and the frequency shifts f_{x, k} and f_{y, k} are determined by the illumination wavelength and the incident angle. After the object intensity is sampled by an image sensor array with a pixel pitch of Δx and Δy, the discrete Fourier transform (DFT) of the sensor's output can be expressed as follows:

$${I}_{sampled , k} = {\sum }_{u , v = 0 , \pm 1 , …} {I}_{pix , k} ( {f}_{x} - \frac{u}{Δ x} , {f}_{y} - \frac{v}{Δ y} ) \qquad ( 17 )$$

where u and v are integers and fₓ and f_{y} are discrete spatial frequency values. Note that I_{pix, k}(fₓ, f_{y})=Iₖ(fₓ, f_{y})·Pₖ(fₓ, f_{y}), where Pₖ(fₓ, f_{y}) represents the Fourier transform of the pixel function, i.e., the 2D responsivity distribution within each pixel: pₖ(x, y). Variables u and v represent the order of spatial aliasing due to pixelation, and (u, v)=(0, 0) corresponds to the non-aliased real (i.e., target) signal. The periodic nature of the DFT enables one to extend the expression of I_{sampled, k} to a broader frequency space by upsampling. Based on these definitions, one can express the undersampled or pixelated lens-free hologram at a given wavelength λₖ as follows:

$${I}_{sampled , k} = {\sum }_{u , v} [ {δ}_{uv} + {T}_{uv , k} \cdot {S}_{uv , k} + {( {T}_{uv , k}^{-} \cdot {S}_{uv , k}^{-} )}^{*} + {SS}_{uv , k} ] \cdot {P}_{uv , k} \qquad ( 18 )$$

The non-aliased target signal oₖ(x, y) or its spatial Fourier spectrum can be obtained under (u, v)=(0, 0), i.e., δ₀₀+S_{00, k} which can be written as follows:

$$( {δ}_{00} + {S}_{00 , k} ) \cdot {P}_{00 , k} = {T}_{00 , k}^{*} \cdot {I}_{sampled , k} - {T}_{00 , k}^{*} \cdot {T}_{00 , k}^{- *} \cdot {P}_{00 , k} \cdot {S}_{00 , k}^{- *} - {\sum }_{u \neq 0 , v \neq 0} ( {T}_{00 , k}^{*} \cdot {T}_{uv , k} \cdot {P}_{uv , k} \cdot {S}_{uv , k} + {T}_{00 , k}^{*} \cdot {T}_{uv , k}^{- *} \cdot {P}_{uv , k} \cdot {S}_{uv , k}^{- *} ) - {\sum }_{u \neq 0 , v \neq 0} {T}_{00 , k}^{*} \cdot {δ}_{uv} - {\sum }_{u , v = 0 , \pm 1 , …} {T}_{00 , k}^{*} \cdot {P}_{uv , k} \cdot {SS}_{uv , k} \qquad ( 19 )$$

On the left side of Eq. (19), one retains the pixel function P_{00, k}, which can be removed later in the last step of the image reconstruction, using, for example, spatial deconvolution with a Wiener filter. Eq. (19) also shows that to obtain the non-aliased object at (u, v)=(0, 0), one needs to eliminate or subtract four terms from the upsampled and back-propagated holographic term (i.e., T_{00, k}*·I_{sampled, k}). To this end, the first item to eliminate, T_{00, k}*T_{00, k}*·P_{00, k}·S_{00, k}⁻*, is the twin image noise, a characteristic artifact of in-line holography. The second term in Eq. (19), which contains S_{uv, k} and S_{uv, k}⁻* (u≠0, v≠0) in the summation, represents the effects of spatial aliasing and undersampling for both the real and twin image terms. The third item, which contains δᵤᵥ in the summation, is the periodic background artifact generated during the upsampling process, and the last item is the self-interference term and its upsampling related artifacts.

As with the other embodiments, a two-stage reconstruction algorithm for eliminating all four of these items listed on the right side of Eq. (19) using wavelength scanning to enable super-resolved reconstructions of complex (i.e., phase and amplitude) object functions.

Reconstruction Stage 1: Generation of a High-Resolution Initial Guess of the Sample Using Wavelength Diversity

As depicted in FIGS. 2A and 2B, the reconstruction of the sample image involves two stages. First, it should be noted that in Eq. (19) the functions {T_{00, k}*·T_{uv, k} (u≠0, v≠0)} have complex values with unit amplitude, and their phases are highly sensitive to changes in wavelength. Therefore, when the illumination wavelength (λₖ) is scanned over K different wavelengths that are uniformly spread across a narrow bandwidth, the set of functions {T_{00, k}*·T_{uv, k} (u≠0 or v≠0)} can be considered rotating unit vectors, and by summing all these rotating vectors as a function of wavelength, one obtains the following:

$$\vert {\sum }_{k = 1}^{K} {T}_{00 , k}^{*} \cdot {T}_{uv , k} \cdot {P}_{uv , k} \vert << K \cdot \vert {P}_{uv , k} \vert \qquad ( 20 )$$

This expression indicates that by summing all the back propagations at different wavelengths (over a narrow spectral range of 10-30 nm, for example), the reconstructed image, i.e., δ₀₀+S_{00, k} or (δ₀₀+S_{00, k})·P_{00, k}, can be significantly enhanced, whereas the spatial aliasing and undersampling related terms with T_{00, k}*·T_{uv, k} will be considerably suppressed. Therefore, in this first stage of the reconstruction process, a high-resolution initial guess of the sample is generated by summing all the upsampled and back-propagated raw measurements, i.e., low-resolution diffraction patterns. The artifact items {(δᵤᵥ(u≠0, v≠0)} are subtracted before the back-propagation step to create a cleaner image.

It should be noted that modifying Eq. (20) into a weighted average at each spatial frequency point could achieve better suppression of spatial aliasing and undersampling-related artifacts. However, using the computation platform used for experimental results, which is based on a central processing unit (CPU), the search for optimal weighting factors at each frequency point will significantly increase the total computation time. Therefore, in this implementation, a simpler summation approach was chosen to minimize the computation time for the generation of the initial object guess. The spatial aliasing and undersampling-related artifacts of this initial guess will be further eliminated and cleaned up during the second stage of the algorithm as explained below.

Reconstruction Stage 2: Multi-Wavelength-Based Iterative Pixel Super-Resolution and Phase Retrieval

The second stage of the numerical reconstruction involves an iterative algorithm, which contains four sub-steps in each iteration:

(1) Knowing each raw measurement's corresponding wavelength and incidence angle, one applies the corresponding plane wave illumination on the initial guess of the sample (from Stage 1) and propagate the optical field from the object plane to the image sensor plane using the angular spectrum approach.

(2) The amplitude of the high-resolution field on the image sensor plane is updated using the low-resolution measurement at the corresponding wavelength. To this end, the intensity of the high-resolution field is convolved with the image sensor's pixel function and downsampled to the same grid size as the pixelated raw measurement. The difference between the raw measurement and the downsampled intensity map is considered a low-resolution “correction” map for each illumination wavelength. A high-resolution correction map can then be generated by taking the Kronecker product of this low-resolution map and the pixel function. To perform a smooth update, this high-resolution correction map is added to the high-resolution intensity distribution with a relaxation parameter, typically set to approximately 0.5. After the smoothed update, a Wiener deconvolution filter that incorporates the image sensor's noise level is applied to this updated intensity distribution. The square root of this filtered high-resolution intensity distribution is then applied to the amplitude of the field on the sensor plane while the phase map is kept unaltered.

(3) This updated field is then back-propagated to the object plane.

(4) The back-propagated field is used to update the transmission field on the object plane. This update is performed in the frequency domain within a circular area as seen in FIG. 2B whose center is determined by the corresponding illumination wavelength and angle. The radius of this circle is defined by the boundary within which all the spatial frequencies experience an attenuation of less than 3 dB after propagation in the spatial domain. This update on the object plane is also smoothed using a relaxation factor of approximately 0.5. After the update, the phase of the field on the object plane is converted to an optical path length map, and its amplitude is directly used as the transmission of the object.

The four steps described above are performed for every raw (i.e., undersampled) measurement captured by the image sensor array. It is considered one iteration cycle when each one of the raw measurements has been used for amplitude update. Typically after 5-10 iteration cycles, the reconstruction converges. The convergence condition for the iteration is defined using Equation (15) above.

Phase Retrieval Using Multi-Height and Synthetic Aperture Techniques

Multi-height and synthetic aperture techniques have been proven to be robust phase retrieval methods for lens-free on-chip imaging. In previously reported lens-free reconstructions, pixel super-resolution and phase retrieval are carried out sequentially: at each height or illumination angle, lateral shift-based pixel super-resolution is first performed to obtain high-resolution diffraction patterns on the image sensor plane. These super-resolved diffraction patterns are then used by an iterative phase retrieval algorithm, in which wave propagations between the object plane and the image sensor plane are executed repeatedly. However, in wavelength-scanning-based pixel super-resolution, raw measurements are essentially undersampled versions of different holograms. Therefore, the same iterative algorithm detailed in the previous subsection (i.e., Reconstruction Stage 2) is used to realize resolution enhancement and phase retrieval altogether. More specifically, in the multi-height configuration, the sample is illuminated sequentially at each wavelength, and the corresponding lens-free holograms are captured before the vertical scanning stage moves the sample or the image sensor to the next height. Each height will be labeled with index l; therefore, all the measurements {I_{sampled, k}} and the corresponding transfer functions {Hₖ} and {T_{uv, k}} that are used in the previous derivations can be relabeled as {I_{sampled, kl}}, {Hₖₗ} and {T_{uv, kl}}, respectively. During the numerical reconstruction process, all the raw holograms are upsampled, back-propagated, and then summed together to generate the high-resolution initial guess at a given height. In Stage 2 of the reconstruction algorithm, the aforementioned four-step process is applied to each raw measurement. The same set of operations and processing also apply to the synthetic aperture technique, except that index l now refers to each illumination angle instead of sample height.

In general, for pathology slides such as blood smears and Pap smears, the optical path length difference between the sample (i.e., biological tissue) and the medium (i.e., air or the sealing glue) is rather small. Under these circumstances, phase unwrapping is not a concern; therefore, in the phase recovery process, one can use a scrambled order of {I_{sampled, kl}} in each iteration cycle. However, when working with samples with larger optical path length differences, such as grating lines carved into a glass substrate, one extra step, i.e., phase unwrapping, must be added after the reconstruction, and the order of iterations must be modified accordingly.

Multi-Wavelength Phase Unwrapping

A robust phase unwrapping algorithm requires high-resolution and phase-retrieved reconstructions at multiple wavelengths; therefore, the raw measurements are divided into subsets, in which the wavelengths are identical or very similar (e.g., Δλ≦5 nm), and perform the four-step reconstruction process previously discussed (as part of the Reconstruction Stage 2) on each subset separately. For example, reconstruction No. 1 uses subset {I_{sampled, kl}|k=1, l=1, . . . L}, No. 2 uses {I_{sampled, kl}|k=2, l=1, . . . L}, etc. When the iterations for all these subsets are completed, one obtains high-resolution (i.e., super-resolved) phase-retrieved reconstructions at multiple wavelengths, i.e., {Oₖ}, whose phase maps {φ_{k, wrapped}} need unwrapping. Using these wrapped phase maps {φ_{k, wrapped}} at multiple wavelengths, phase unwrapping is performed to accurately reveal the optical path length differences between the sample and the surrounding medium. Assuming that the optical path length difference is ΔL(x, y), the phase distribution at the object plane at each wavelength can be written as φₖ(x, y)=2π·ΔL(x, y)/λₖ. The wrapped phase can thus be expressed as φ_{k, wrapped}(x, y)=φₖ(x, y)±2Nπ, where π<φ_{k, wrapped}≦π and N is an integer. These resulting wrapped phase maps {φ_{k, wrapped}} that are generated through super-resolved and phase-retrieved reconstructions at multiple wavelengths are then fed into an optimization algorithm that finds the optimum path length ΔLₒₚₜ(x, y) at each spatial point (x, y) by minimizing a cost function defined as follows:

$${\sum }_{k = 1}^{K} {\vert {e}^{j {φ}_{k} ( x , y )} - {e}^{j 2 π \cdot Δ {L}_{opt} ( x , y ) / {λ}_{k}} \vert}^{2} \qquad ( 21 )$$

To avoid convergence to a local minimum and reduce the computation cost/time, a search range of [ΔL₀-min{λₖ }/2, ΔL₀+min{λₖ }/2] is defined, where ΔL₀ is the initial guess of the optical path length:

$$Δ {L}_{0} ( x , y ) = \frac{1}{2 π \cdot ( K - 1 )} {\sum }_{k = 2}^{K} [ {φ}_{k} ( x , y ) - {φ}_{k - 1} ( x , y ) ] \cdot \frac{{λ}_{k} {λ}_{k - 1}}{{λ}_{k - 1} - {λ}_{k}} \qquad ( 22 )$$

where the total number of wavelengths (K) is typically 5-10. Within this search interval, the values are scanned to find the optical path length ΔLₒₚₜ(x, y) that minimizes the cost function, resulting in an unwrapped object phase image.

In one embodiment, a fundamentally new pixel super-resolution method is described that utilizes wavelength scanning to significantly improve the resolution of an undersampled or pixelated imaging system, without the use of any lateral shifts or displacements. In this technique, the sample is sequentially illuminated at a few wavelengths that are sampled from a rather narrow spectral range of 10-30 nm. Compared with sub-pixel displacement or lateral shift-based super-resolution techniques, wavelength scanning introduces a uniform resolution improvement across all the directions on the sample plane and requires significantly fewer raw measurements to be made. Making fewer measurements without sacrificing performance could greatly benefit high-speed wide-field imaging, field-portable microscopy and telemedicine applications, which are all sensitive to data transmission and storage.

Using an experimental setup, the effectiveness of this new wavelength-scanning-based pixel super-resolution approach has been demonstrated using lens-free holographic microscopy (FIG. 1C) to improve the resolution and the effective numerical aperture (NA) of a unit magnification imaging system by a factor of approximately four in all directions. Using twelve (12) different illumination wavelengths between 480 nm and 513 nm, a half-pitch resolution of approximately 250 nm was achieved and an effective NA of approximately 1.0 across a large FOV of >20 mm², which constitutes a space-bandwidth product of >1 billion. At the heart of these results is an iterative pixel super-resolution algorithm that was developed to obtain high-resolution complex (i.e., phase and amplitude) reconstructions from undersampled (i.e., pixelated) lens-free digital holograms acquired at different wavelengths.

Optical Setup

For wavelength scanning experiments, an in-line holographic imaging system 10 that disclosed in FIGS. 1A-1C was used. The optical setup of the lens-free microscope consists of three major components: a light source, an image sensor array, and a sample. A fiber-coupled, wavelength-tunable light source (WhiteLase-Micro, model VIS, Fianium Ltd, Southampton, UK) was used to perform the wavelength scanning. During the imaging process, the central wavelength of the source is scanned within a spectral range of 10-30 nm (e.g., from 498 nm to 510 nm) with a step size of approximately 3 nm. The spectral linewidth of illumination at each wavelength is approximately 2 nm, and the power of the light source is adjusted to approximately 20 μW. The image sensor chip was a color CMOS sensor chip with a pixel size of 1.12 μm manufactured for cellphone camera modules (IU081, Sony Corporation, Japan). During the imaging process, the sample is mounted on a transparent substrate and placed 100-500 μm above the image sensor chip. The wavelength-scanning-based pixel super-resolution approach was merged with both multi-height and synthetic aperture imaging configurations to obtain phase-retrieved, high-resolution reconstructions of the sample. For synthetic-aperture-based imaging, the fiber outlet of the light source is mounted on a rotational arm (PRM1Z8, Thorlabs, New Jersey, USA), and the image sensor is placed on a stage that can rotate over a horizontal plane. Therefore, the incident light can be set to arbitrary illumination angles, which is required for the synthetic aperture approach. For multi-height-based phase retrieval, the incremental height change between the image sensor and the sample is enabled by a mechanical positioning stage (MAX606, Thorlabs, New Jersey, USA). The image sensor is mounted on this mechanical stage, whereas the sample is held by a 3D-printed sample holder. After completing image capture for each height, the stage lowers the image sensor by 10-15 μm on average before the image capture for the next height starts. During the imaging process, all the necessary steps, including the wavelength scanning of the light source, multi-height and synthetic-aperture-related scans and data acquisition using the image sensor chip are automated by a custom-written LabVIEW code (Version 2011, National Instruments, Texas, USA).

Wavelength Calibration and Dispersion Compensation

Wavelength calibration of the light source is achieved using an optical spectrum analyzer (HR2000+, Ocean Optics, Amersham, UK). The intensity-weighted average wavelength of each measured spectrum is considered as the illumination wavelength. To achieve optimal resolution, the refractive index of the glass substrate (100 μm, N-BK7, Schott AG, Mainz, Germany) at each wavelength is also corrected using the dispersion formula for borosilicate glass.

Sample Preparation

The grating lines used for resolution quantification are fabricated on an approximately 100-μm glass slide (N-BK7, Schott AG, Mainz, Germany) using focused ion beam (FIB) milling. Unstained Papanicolaou (Pap) smear slides are prepared through the ThinPrep® method (Hologic, Massachusetts, USA). The blood smear samples are prepared using EDTA (ethylenediaminetetraacetic acid) anticoagulated human blood and stained with Wright's stain.

Computation Platform Used for Super-Resolved Image Reconstructions

The reconstructions were performed using MATLAB® (Version R2012a, MathWorks, Massachusetts, USA) on a desktop computer equipped with a 3.60-GHz central processing unit (Intel Xeon ES-1620) and 16 GB of random-access memory. For a 1×1 mm² sub-region with an upsampling factor of seven, one iteration of the wavelength-scanning super-resolution routine takes approximately 1.2 seconds. For example, one cycle of the algorithm, which undergoes all the undersampled measurements (e.g., seven wavelengths for each angle/height, and 22 angles/heights in total), takes approximately 3 minutes. In this implementation, the iterations did not use either GPU (graphics processing unit) or parallel computing, which could significantly improve the overall computation time. The total image reconstruction time could be further improved by implementing the algorithm in the C language rather than MATLAB®.

Results and Discussion

The physical basis for wavelength-scanning pixel super-resolution is the strong wavelength dependence of the undersampled interference patterns in coherent or partially coherent diffraction imaging systems such as lens-free, holographic microscopy or defocused lens-based imaging systems. When illuminated at slightly different wavelengths, the high-frequency interference fringes caused by object scattering will change, causing the undersampled output of the image sensor chip to change as well. In the spatial frequency domain, the aliasing signal caused by pixel-induced undersampling is modulated by a complex transfer function whose phase is rather sensitive to even small wavelength changes, which makes it possible to use wavelength diversity within a narrow spectral range (i.e., 10-30 nm) to cancel out the spatial aliasing term and enhance the resolution of the reconstructions beyond the pixel pitch.

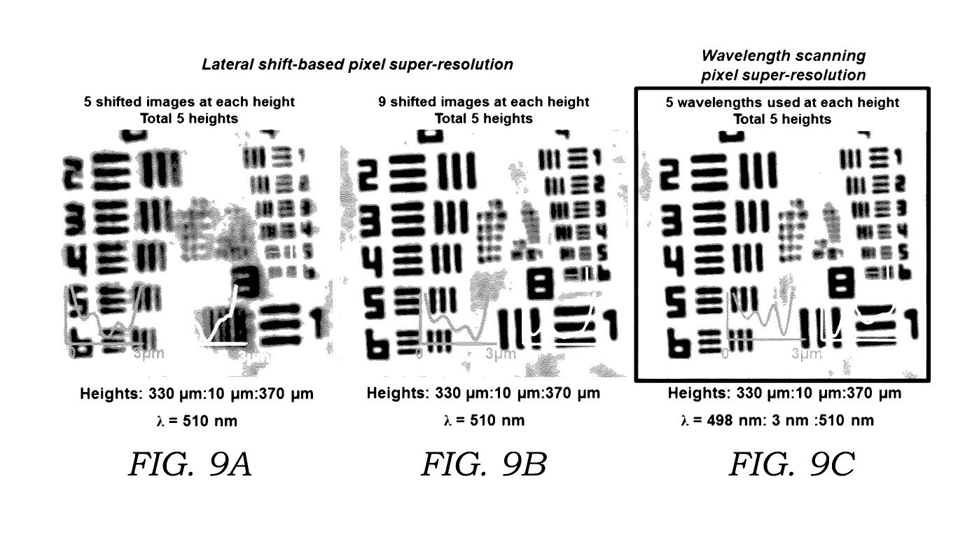

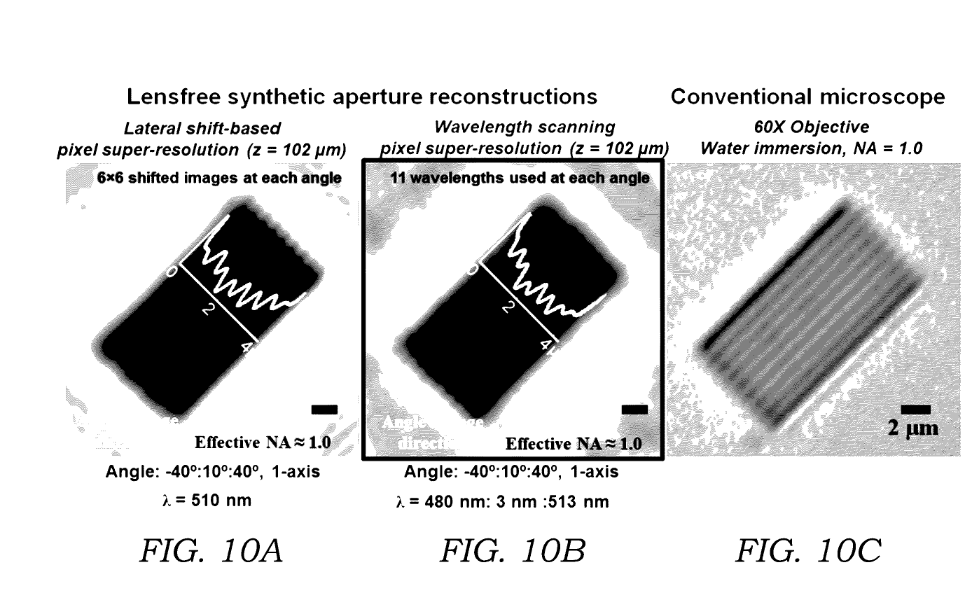

Without pixel super-resolution, lens-free microscopy with a unit magnification on-chip imaging geometry (in which the sample FOV equals the active area of the sensor array) can achieve a half-pitch resolution close to the image sensor's pixel pitch (i.e., approximately 1 μm in FIG. 8A, using a CMOS sensor that has a 1.12-μm pixel pitch). For the same configuration depicted in FIG. 8A, utilizing the wavelength diversity in illumination boosts the half-pitch resolution to approximately 0.6 μm by using five different wavelengths between 498 and 510 nm (see FIGS. 8C and 8D). When integrated with the multi-height phase retrieval technique, the resolution can be further improved to approximately 0.5 μm, corresponding to an effective NA of approximately 0.5 as seen in FIG. 9C. Using the synthetic aperture technique, however, can provide not only twin image elimination but also a significant increase in spatial bandwidth of the reconstructed images; these benefits enable one to take full advantage of the wavelength-scanning-based pixel super-resolution technique and achieve a half-pitch resolution of approximately 250 nm with an effective NA of approximately 1.0 under a unit magnification geometry, where the FOV is >20 mm² (see FIG. 10B).

In addition to delivering a competitive resolution and NA, the wavelength-scanning-based super-resolution approach also offers better data efficiency compared with lateral shift-based pixel super-resolution techniques, i.e., fewer raw measurements are needed for the same resolution improvement. In lateral shift-based pixel super-resolution, the sub-pixel shifts between the raw measurements are obtained by moving the light source, image sensor and/or the sample with respect to each other, and the resolution improvement is direction dependent. Therefore, sub-pixel shifts that spread uniformly within a two-dimensional pixel area are preferred in lateral shift-based pixel super-resolution techniques to achieve optimal resolution enhancement. As a result, the number of raw measurements generally increases as a quadratic function of the pixel super-resolution factor. However, in the wavelength-scanning super-resolution approach, the resolution improvement caused by wavelength diversity is uniform in all lateral directions across the sensor array, which enables us to achieve competitive resolution with much fewer raw measurements compared with lateral shift-based super-resolution. To exemplify this important advantage of our approach, in a normal-illumination configuration, compared with the lateral shift technique, which needs nine measurements to achieve a half-pitch resolution of approximately 0.6 μm (FIGS. 8B and 8C), the wavelength-scanning technique requires only five raw measurements (FIG. 8D) to reach the same imaging performance. Similarly, when combined with multi-height phase retrieval, wavelength-scanning super-resolution requires 25 raw measurements in total (five wavelengths at each of five heights), which is significantly smaller than the number required using lateral shifts (i.e., 45 raw measurements as shown in FIG. 9C). When integrated with synthetic-aperture-based lens-free imaging, an even higher spatial resolution can be achieved using wavelength diversity, and the advantages of wavelength scanning over lateral shifts become more significant. As shown in FIG. 10A, to achieve a half-pitch resolution of approximately 250 nm in all directions, the lateral shift-based super-resolution technique requires a total of 612 images (6×6 raw images at each one of the 17 illumination angles), whereas the presented wavelength-scanning technique only needs 204 images (12 wavelengths at each one of the 17 angles—FIG. 10B), corresponding to a 3-fold reduction in the number of images. Taking into account the wait time for the mechanical components in our bench-top system, the lateral shift-based technique at multiple illumination angles takes approximately 21.5 minutes in total, whereas our wavelength-scanning technique takes only approximately 4.8 minutes, showing a significant improvement in the imaging time. This important advantage in terms of the reduced number of measurements can also be translated into smaller data storage space, which is critical for increasing the speed and utility of high-resolution wide-field imaging techniques.

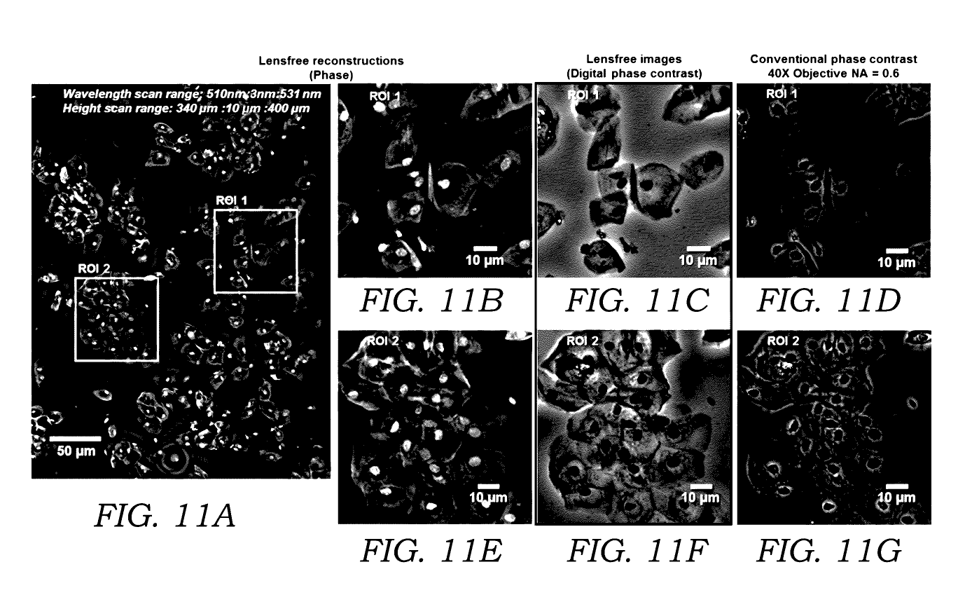

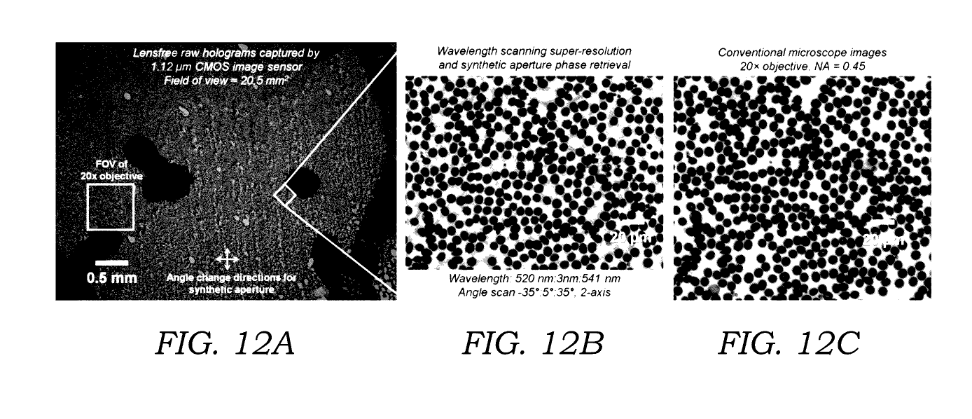

One should re-emphasize that wavelength-scanning super-resolution requires only a few wavelengths taken from a narrow spectral range (e.g., 10-30 nm). With this new super-resolution approach, one can obtain high-resolution amplitude reconstructions of not only colorless but also colored (i.e., stained/dyed) samples without further modifications in the reconstruction algorithm. This capability has been demonstrated by imaging various biological samples, including unstained Pap smears (FIGS. 11A-11G) as well as stained blood smears (FIGS. 12A-12C). Because the lens-free reconstructions provide both amplitude and phase channels, one can also visualize the reconstructed images using different methods to create, for example, a digital phase contrast image as illustrated in FIGS. 11C and 11F.

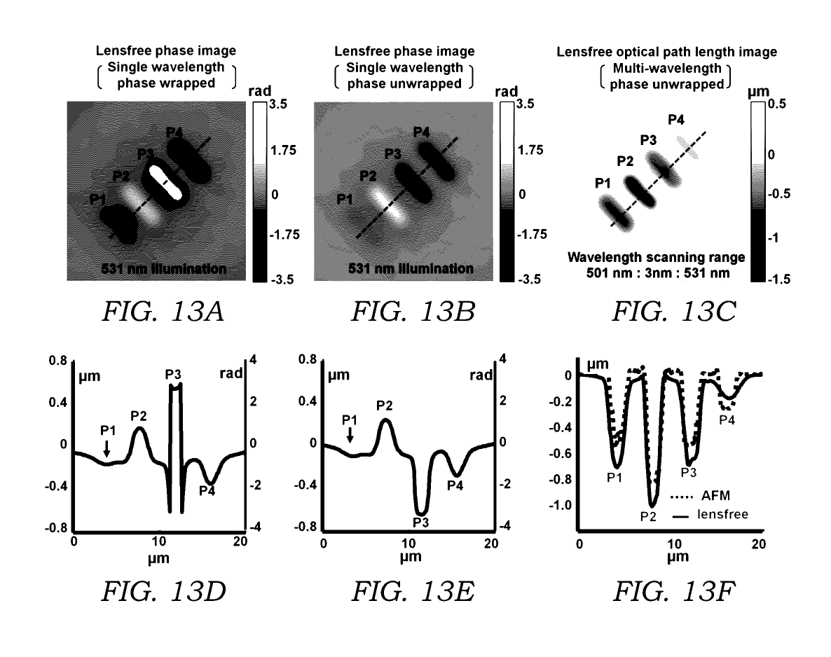

In addition to significantly improving resolution and mitigating undersampling, wavelength diversity also enables one to perform robust phase unwrapping and reveal the optical path length differences between a given sample and surrounding medium. The retrieved phase reconstruction from a single wavelength is constrained to its principle value (−π, π], and therefore large optical path length differences can cause polarity errors that may not be corrected even by using state-of-the-art phase unwrapping algorithms (see, for example, FIGS. 13A and 13B). Such polarity errors in phase reconstructions can also be mitigated by detecting the phase differences between the reconstructions at two different wavelengths. However, this two-wavelength phase unwrapping approach still faces the challenge of ambiguity or uniqueness. In addition to achieving pixel super-resolution, wavelength scanning was further utilized to significantly improve the robustness of phase unwrapping by incorporating all the wavelengths of illumination that are used in pixel super-resolution to unwrap the reconstructed phase. The phase unwrapping results shown in FIGS. 13C, 13F clearly illustrate that through optimization one can entirely rule out incorrect optical path length differences within the reconstructed images and achieve robust phase unwrapping in a super-resolved image.

The wavelength-scanning pixel super-resolution approach, together with phase retrieval methods, including multi-height, synthetic aperture, and object-support-based techniques, could constitute high-resolution imaging systems with greatly improved imaging speed. For a bench-top system, high-speed wavelength scanning can be realized using a fast tunable source (employing, for example, an acousto-optic tunable filter with a supercontinuum source) synchronized with the image sensor chip. Compared with lateral shift-based super-resolution setups, such a combination avoids motion blur and could increase the data acquisition speed to the maximum frame rate of the image sensor. Furthermore, the lateral shifts generated by the source-shifting approach are determined by both the sample-to-image sensor and sample-to-aperture distances, which can make it challenging to generate optimized lateral shifts for samples at different vertical heights. The wavelength-scanning approach, however, is performed with evenly distributed wavelengths regardless of sample height. Therefore, the wavelength-scanning pixel super-resolution may be more favorable that lateral shifting techniques for building high-resolution wide-field microscopes with high imaging speeds. Additionally, the better data efficiency of the wavelength-scanning super-resolution approach can reduce the cost of data storage and transmission, benefiting telemedicine implementations and server-based remote reconstructions.

In addition to delivering competitive results on a bench-top system, the presented wavelength-scanning pixel super-resolution approach also holds great potential for field-portable microscopy applications. Compared with lateral shift-based pixel super-resolution, the wavelength-scanning approach does not require any mechanical motion or fiber bundle (although the integration of such options may be optional), which could make the mobile imaging platform more robust. Because the wavelength scanning range is narrow (i.e., 10-30 nm), the combination of a few light-emitting diodes (LEDs), each with a standard spectral bandwidth of 15-30 nm, and a variable optical thin-film filter to narrow the LED spectra can be used to implement wavelength-scanning super-resolution in a field-portable and cost-effective design.

It should further be emphasized that the wavelength-scanning pixel super-resolution approach, in addition to lens-free or holographic diffraction-based imaging systems, can also be applied to lens-based point-to-point imaging modalities. By introducing a simple defocus condition into a lens-based imaging system (by, for example, introducing a relative axial shift of the sensor array, object and/or the objective lens along the z direction of the optical path), the entire wavelength diversity framework described herein would be able to achieve pixel super-resolution. This was experimentally demonstrated with the wavelength-scanning pixel super-resolution approach using a conventional lens-based microscope with a 10× objective lens (NA=0.3) and a CMOS sensor chip with a pixel size of 3.75 μm (see FIG. 14A). To significantly expand the FOV of the microscope from approximately 0.17 mm² to 1.20 mm², a 0.38× camera adaptor was used, which created an effective pixel size of approximately 0.99 μm, limiting the resolution of the microscope because of pixelation (see FIG. 14B). To considerably improve the resolution back to the resolving capability of the objective lens (dictated by its NA), the target object was defocused by small increments of approximately 20 μm between 160 μm and 300 μm. The illumination wavelength was scanned between 500 nm and 521 nm with a step size of 3 nm. Using the defocused microscope images in the wavelength-scanning super-resolution algorithm described herein, the resolution of the reconstructed image was significantly improved as seen in FIG. 14D, matching the resolution determined by the NA of the objective lens while also expanding the image FOV by approximately 7-fold (i.e., 1.20 mm² vs. 0.17 mm²). These results confirm that the wavelength-scanning pixel super-resolution technique is broadly applicable to various lens-based and lens-free coherent and partially coherent wide-field imaging modalities.

While embodiments of the present invention have been shown and described, various modifications may be made without departing from the scope of the present invention. For example, while several embodiments are described in the context of lens-free embodiments, the reconstruction methods described here may also be used with lens-based microscope systems. The invention, therefore, should not be limited, except to the following claims, and their equivalents.

What is claimed is:

1. A method for obtaining a high resolution image of one or more objects contained within a sample comprising:
illuminating the sample with a light source emitting partially coherent light or coherent light, wherein the sample is interposed between the light source and an image sensor with a sample-to-image sensor distance zₖ;
obtaining a plurality of lower resolution hologram image frames of the objects with the image sensor, wherein the plurality of lower resolution hologram image frames are obtained at different (1) sample-to-image sensor distances zₖ or (2) different illumination angles θₖ,φₖ;
generating from the plurality of lower resolution hologram image frames a high-resolution initial guess of the objects based on a summation of upsampled holograms in the lower resolution image frames;
iteratively eliminating twin image noise, aliasing signal, and artifacts and retrieving phase information from the high-resolution initial guess, wherein the iterative process comprises:
forward-propagating the high-resolution initial guess from an object plane to an image sensor plane to generate a high-resolution forward-propagated field;
updating an amplitude of the high-resolution forward-propagated field using holograms in the lower resolution hologram image frames;
back-propagating the updated high-resolution forward-propagated field to the object plane;
updating a transmitted field of the object at the object plane in the spatial frequency domain; and
outputting a phase retrieved high resolution image of the one or more objects contained within the sample based on the updated transmitted field of the one or more objects.

2. The method of claim 1, further comprising obtaining a plurality of additional lower resolution hologram image frames of the one or more objects with the image sensor, wherein the additional lower resolution hologram image frames are obtained using sub-pixel lateral shifts and wherein the additional lower resolution hologram image frames are used to generate the high-resolution initial guess of the objects.

3. The method of claim 2, wherein the sub-pixel lateral shifts are obtained at a single sample-to-image sensor distance zₖ.

4. The method of claim 2, wherein the sub-pixel lateral shifts are obtained at a single illumination angles θₖ,φₖ.

5. The method of claim 1, wherein the sample comprises a biological sample.

6. The method of claim 1, wherein the sample comprises a pathology sample.

7. The method of claim 1, wherein the plurality of lower resolution hologram image frames comprise less than fifty (50) image frames.

8. The method of claim 1, wherein the light source comprises a wavelength-tunable light source and wherein the plurality of lower resolution hologram image frames of the objects with the image sensor are obtained at different illumination wavelengths λₖ.

9. The method of claim 8, wherein the different illumination wavelengths λₖ separated by one another by at least 2 nm.

10. The method of claim 8, wherein the different illumination wavelengths λₖ are within a spectrum range less than 30 nm.

11. A method for obtaining a high resolution image of one or more objects contained within a sample comprising:
sequentially illuminating the sample at a plurality of different wavelengths with a light source emitting partially coherent light or coherent light, wherein the sample is interposed between the light source and an image sensor with a sample-to-image sensor distance zₖ;
obtaining a plurality of lower resolution hologram image frames of the objects with the image sensor at the plurality of different wavelengths, wherein the plurality of lower resolution hologram image frames are also obtained at different (1) sample-to-image sensor distances zₖ or (2) different illumination angles θₖ,φₖ;
generating from the plurality of lower resolution hologram image frames a high-resolution initial guess of the objects based on a summation of upsampled holograms in the lower resolution image frames;
iteratively eliminating twin image noise, aliasing signal, and artifacts and retrieving phase information from the high-resolution initial guess, wherein the iterative process comprises:
forward-propagating the high-resolution initial guess from an object plane to an image sensor plane to generate a high-resolution forward-propagated field;
updating an amplitude of the high-resolution forward-propagated field using holograms in the lower resolution hologram image frames;
back-propagating the updated high-resolution forward-propagated field to the object plane;
updating a transmitted field of the object at the object plane in the spatial frequency domain; and
outputting a phase retrieved high resolution image of the objects contained within the sample based on the updated transmitted field of the object.

12. The method of claim 11, wherein the plurality of different wavelengths are separated by one another by at least 2 nm.

13. The method of claim 11, wherein the plurality of different wavelengths span a wavelength range of less than 30 nm.

14. The method of claim 11, wherein the phase retrieved high resolution image comprises a phase unwrapped image obtained from the plurality of different wavelengths.

15. The method of claim 11, wherein the sample comprises a biological sample.

16. The method of claim 11, wherein the sample comprises a pathology sample.

17. A wavelength scanning pixel super-resolution microscope device for imaging a sample comprising:
a sample holder configured to hold the sample;
a wavelength-tunable light source or multiple different light sources configured to illuminate the sample at a plurality of different wavelengths λₖ along an optical path;
a lens or set of lenses disposed along the optical path;
an image sensor configured to receive illumination passing through the sample and lens or set of lenses along the optical path, wherein the at least one of the sample holder, lens, set of lenses, or image sensor are moveable along the optical path to introduce incremental defocusing conditions to the microscope device, wherein the image sensor obtains a plurality of images of the sample at the different wavelengths under the incremental defocusing conditions; and
at least one processor configured to (1) generate a high-resolution initial guess of the sample image based on the plurality of images of the sample at the different wavelengths under the incremental defocusing conditions, (2) iteratively eliminate artifacts and retrieving phase information from the high-resolution initial guess of the sample image, and (3) output a high resolution, phase retrieved high resolution image of the sample.

18. The wavelength scanning pixel super-resolution microscope device of claim 17, wherein the lens or set of lenses comprises an objective lens and the objective lens is moved incrementally.

19. The wavelength scanning pixel super-resolution microscope device of claim 17, wherein the different illumination wavelengths λₖ separated by one another by at least 2 nm.

20. The wavelength scanning pixel super-resolution microscope device of claim 17, wherein the incremental defocusing conditions are created by moving one or more of the sample, image sensor, or the lens or set of lenses.
